(19) United States
(12) Patent Application Publication
(10) Pub. No.: US 2026/0044112 A1
(43) Pub. Date: Feb. 12, 2026

(54) METHOD FOR REPLICATING A PLURALITY OF HOLOGRAMS BY MEANS OF A TYPECASE PRINCIPLE

(71) Applicant: Carl Zeiss Jena GmbH, Jena (DE)

(72) Inventors: Markus Giehl, Jena (DE); Mirko Riethmüller, Jena (DE); Isabelle Maret, Jena (DE)

(21) Appl. No.: 19/101,889

(22) PCT Filed: Aug. 8, 2023
(86) PCT No.: PCT/EP2023/071923

§ 371 Date: Feb. 6, 2025

(30) Foreign Application Priority Data
Aug. 9, 2022 (DE) 10 2022 119 988.6

(51) Int. Cl. G03H 1/30

(52) U.S. Cl. CPC G03H 1/30

(57) ABSTRACT

A method includes providing a multiplicity of masters, each of the masters having a substrate body and at least one master hologram, selecting a sequence of masters from the multiplicity of masters based on a plurality of holograms to be replicated and arranging the sequence of masters on a first carrier to align upper faces of the masters in a horizontal plane, detachably laminating a light-sensitive composite web on the aligned upper faces, exposing the masters to replicate the master holograms in the light-sensitive composite web, and detaching the exposed composite web from the masters. The masters are detachably incorporated in the first carrier such that a sequence and/or composition of the masters for replicating the plurality of holograms is variable. The masters are incorporated in the first carrier such that two or more faces of the masters are optically accessible for exposure.

The invention relates to a method comprising: providing a multiplicity of master elements comprising a substrate body and at least one master hologram, selecting a sequence of master elements from the multiplicity of master elements on the basis of the plurality of holograms to be replicated and arranging the sequence of master elements on a first carrier means such that upper faces of the master elements are aligned in a horizontal plane, detachably laminating a light-sensitive composite web on the aligned faces of the master elements, exposing the master elements in order to replicate the master holograms in the light-sensitive composite web, and detaching the exposed composite web from the master elements, wherein the master elements are detachably incorporated in the first carrier means such that a sequence and/or composition of the master elements for the replication of the plurality of holograms is variable, and wherein the master elements are incorporated in the first carrier means such that two or more faces of the master elements are optically accessible for exposure purposes.

### BACKGROUND AND PRIOR ART

The invention relates to the field of replication of holograms.

HOEs (Holographic Optical Elements) typically denote optical components in which holographic properties are used to attain a specific beam path of the light, such as e.g. transmission, reflection, diffraction, scattering and/or deflection, etc. As a result, desired optical functionalities may be implemented in any desired substrate in a compact manner. The holographic properties preferably exploit the wave nature of light, in particular coherence and interference effects. Both the intensity and the phase of the light are taken into account here.

Such holographic elements find application in many fields, such as e.g. in transparent displays (e.g. in display windows, refrigeration equipment, vehicle windowpanes), for illumination applications, such as information or warning signals in glass faces, light-sensitive detection systems for example for interior monitoring (eye tracking in vehicles or presence status tracking of persons in interiors). Many HOEs have large dimensions, for example covering an entire windshield. Then again, HOEs might also have smaller dimensions, for example for use in banknotes and tamper-proof seals.

Holograms are created by the interference of a reference beam with the light reflected off the surface of an object (object beams). Three-dimensional objects have traditionally been used in order to produce unique, customized holograms. These days, such holograms can be produced using purely computer-generated methods, in which a holographic interference pattern is calculated digitally and “printed” on a light-sensitive material by computer-controlled coherent light sources. This makes it possible for holograms to be produced from a computer-generated image and is considered particularly suitable for the production of one-off versions of holograms, for the production of customer-specific holograms or for the production of master holograms that are replicated at a later stage. An exemplary method of this type is known as “laser scanning holographic lithography”. This method requires the use of very fine laser beams with a beam width of the order of micrometers. For this reason, the method is time and cost-intensive, and so the use is uneconomical, especially in the case of very large master holograms.

By contrast, commercially available HOEs are often produced by means of replication methods in mass production. Such replication methods generally use a master hologram having the image to be copied. Often, the dimensions of the master hologram are similar to those of the HOE. The master hologram materials are frequently more expensive than the replicated HOEs since the master holograms typically consist of a more durable metal or are embedded as a master element in a transparent substrate of great rigidity and high surface quality. The production of master holograms is also cost-intensive on account of the use of user-defined methods, independently of whether these are traditional or computer-generated methods.

Master holograms are often stored in a substrate body bearing the master hologram. Preferably, the substrate body is transparent. The substrate body preferably has a plurality of faces, including an upper or lower face which may be aligned horizontally. The combination of the master hologram with the substrate body forms a master element. As a rule, the size of the master element is a multiple of the size of the master hologram. The significant weight of the master elements is caused by the hard, transparent materials such as glass that are used for the substrate body.

The continual replication of a single master hologram in order to produce a number of identical copies of such HOEs is known. As a rule, this process is implemented by a stamping method in a light-sensitive material for the purpose of producing reflection holograms. The replication may also be implemented by an optical exposure, in order to create a volume hologram. In these cases, a light-sensitive material is brought into optical contact with a master element and exposed using coherent light. In order to allow continual processing and increase the speed of the method, the light-sensitive material may be provided in the form of a web and transported through different workstations by rollers in order to produce the HOEs. Such webs are frequently only obtainable in standard widths, which for example are adapted to the width of rollers in the workstations.

Small HOEs (width or length <150 mm) in particular often do not allow their replication on such a web using a single master element to be performed efficiently in terms of processes or materials. Especially in cases where the width of the web far exceeds the width of the HOE, a large part of the light-sensitive web must be cut off and disposed of in subsequent work steps. This leads to waste material and increased costs, and moreover restricts the speed and efficiency of the copying procedure.

One alternative may lie in the use of a plurality of master holograms in order to produce the HOEs next to one another over the width of the web. This improves the material utilization but leads to challenges as regards the placement of the master holograms. In particular, unevenness between the master holograms may lead to a poor optical contact between the web and the master holograms, and so unwanted reflections occur at the interfaces. One possible solution to this problem consists of integrating various master holograms in a single, large-area master element. A large-area master element may offer a perfectly flat and continuous surface, in order to establish the necessary optical contact with the web.

However, the production of large master elements with a multiplicity of master holograms is expensive, inter alia because the production of large-area optically flawlessly polished substrates is non-trivial. Moreover, it is more difficult to move such master elements on account of their weight, making an introduction and removal of such large master elements in a production line more difficult. Moreover, storing and keeping a large number of heavy and cost-intensive master elements logistically available is not very practical.

Moreover, space-efficient positioning of master holograms may lead to unwanted optical disturbances in the created HOE. For example, reference beams used to expose a master hologram may propagate or be scattered and reach an adjacent hologram, leading to the latter also being inadvertently exposed. To avoid this, large buffer spacings are required between the master holograms; this has a disadvantageous effect on a material-efficient use of both the master elements and the light-sensitive web.

Identical master holograms may be present on a master element in order, as explained above, to create a more efficient utilization of a light-sensitive web. In such a case, one and the same scanning laser may expose all master holograms from the same angle.

However, it may also be preferable for the intention to be to simultaneously replicate master holograms of different motifs. Firstly, this may be preferable in order to simultaneously use a replication apparatus for various applications. Then again, the provision of a large-area HOE may require the replication of a multiplicity of different types of HOEs, which are subsequently stitched together to form a large-area HOE.

In this case, the various holograms to be replicated may differ from one another not only on account of the motifs contained therein but also on account of their type. For example, transmission holograms and reflection holograms are known; these are in turn subdivided into categories such as edge lit, back lit, etc. Holograms for different purposes must be exposed in different ways and from different angles, for example in order to correspond to the position of a light source that is intended to be used to reconstruct the hologram. In order to reduce the outlay, it would also be advantageous if different types of master holograms that have different motifs and also use different exposure methods could be exposed on the web in a single apparatus.

Simple laser scanning over the entire master element is unsuitable in the event of the same master element comprising a multiplicity of master holograms that have different motifs and are of different types. The design of an optical structure that serves to expose different master holograms in the same master element from different angles without erroneous exposure of regions is complex. Moreover, this case would necessitate a particularly large separation of the master holograms in the master element in order to avoid an unwanted superposition of light beams.

A further problem arises should one or more master holograms in the master element be found to be erroneous or degraded or be changed. Since the master holograms are securely bonded to the substrate body, they cannot be exchanged on an individual basis without replacing the entire master element.

This leads to a significant loss of material and increased production costs, especially if changes are only required in a partial region of a larger master hologram. The method becomes impracticable if frequent changes occur and only small series are produced. An alternative consists in producing each hologram using a computer-controlled lithography technique.

However, as mentioned above, this is uneconomical for most commercial applications.

Hence there is a need for the provision of a more efficient method for replicating holograms, which allows changes to be made easily and in particular is suitable for a more flexible, material-saving replication of holograms in small and large dimensions. Furthermore, it would be desirable to develop simple options for varying master holograms between short series, wherein the master holograms are easily storable and exchangeable.

The known methods of series replication are not readily suitable for many applications, e.g. for the production of personalized security features (for example a holographic date of birth, a holographic issue date, a holographic serial number or the like). This is due to the fact that the hologram to be produced may either be unique or contain a unique combination of features such as numerals, symbols and images. Moreover, it may be necessary for these holograms to be different types with different exposure requirements. For example, transmission holograms may be required for use in glasses with a specific tint or power (cf. WO2016202595A1). It may likewise be necessary for the holograms to be reflection holograms, for example for use in a display. The holograms might need to have a specific color or need to be visible from only a specific angle.

US2007024939A1 has disclosed a method which increases the flexibility of use of master holograms in a production series. The method comprises a light-sensitive web being brought into contact with a matrix of small separate master elements. The master elements themselves comprise changeable features such as e.g. a counter and are arranged in a support such that only their top side is accessible to the exposure. The arrangement thus allows exposure from one side only, in order to exclusively create reflection holograms.

Moreover, the arrangement known from US2007024939A1 does not offer a precise guidance of the exposure light to either the master elements or the light-sensitive web. The angles from which the light incident through the light-sensitive web can reach the master elements are limited since the light can only be incident on the upper side of the master elements. Therefore, all master elements must be exposed essentially by way of the same technique. That is to say, even though different master elements (or “objects”) may be copied in one production run, they must all be copied in the same way in order to exclusively form reflection holograms. To this end, the master holograms are located in front of a reflected background.

Moreover, protection of adjacent copies from disturbances by light reflected off adjacent master holograms is not provided. The exposure of the master holograms from above is disclosed as the only option for creating different holograms in the light-sensitive web without giving rise to unwanted superpositions between the various images. The exposure as described in said document requires the reference beam to traverse various components with different refractive indices, by means of which said reference beam is refracted differently. There are interfaces between layers with different refractive indices—for example between the master elements, the light-sensitive web and the surrounding air—and these harbor a great risk of reflections. This may give rise to unwanted exposure patterns.

DE 10 2010 2014 3015 A1 has disclosed a method for replicating a plurality of reflection holograms. The holograms to be copied are provided next to one another on the surface of a drum with a polygonal cross section or prismatic shape, wherein each lateral face of the drum comprises at least one master hologram. For an exposure, a light-sensitive material is guided over the surface of the drum. Rollers are guided over the surface of the drum in order to eliminate air gaps between the light-sensitive material and the drum, especially at the corners of the drum. Like the apparatus according to US2007024939A1, this arrangement only allows an exposure of reflection holograms. Greater flexibility during the exposure of different types of holograms is not provided. Moreover, winding the light-sensitive material over the surface of a prismatic drum with multiple sides may impair the mechanical quality of the light-sensitive material and leave unwanted grooves or folds. Hence, there is a need for an arrangement that allows gentle handling of a composite web in order to perform a flexible replication process.

In light of the known prior art, there consequently is a need for a method which not only enables the replication of different master elements with different master holograms in a single series but also preferably allows a controlled exposure of each master element from a specific direction or using a specific wavelength such that different exposure methods may also be performed within the scope of a single series.

### OBJECT OF THE INVENTION

The problem addressed by the invention is that of providing a method that lacks the disadvantages of the prior art and serves to replicate a plurality of holograms. In particular, a problem addressed by the invention was that of providing a method suitable for the material-saving replication of holograms with great precision and high quality, wherein by preference different holograms with different exposure requirements may also be replicated.

### SUMMARY OF THE INVENTION

The problem is solved by the features of the independent claim. Advantageous configurations of the invention are described in the dependent claims.

The invention relates to a method for replicating a plurality of holograms, comprising the following steps:
a. providing a multiplicity of master elements comprising a substrate body and at least one master hologram,
b. selecting a sequence of master elements from the multiplicity of master elements on the basis of the plurality of holograms to be replicated and arranging the sequence of master elements on a first carrier means such that upper faces of the master elements are aligned in a horizontal plane,
c. detachably laminating a light-sensitive composite web on the aligned faces of the master elements,
d. exposing the master elements in order to replicate the master holograms in the light-sensitive composite web, and
e. detaching the exposed composite web from the master elements,
   wherein the master elements are detachably incorporated in the first carrier means such that a sequence and/or composition of the master elements for the replication of the plurality of holograms is variable, and wherein the master elements are incorporated in the first carrier means such that two or more faces of the master elements are optically accessible for exposure purposes.

The method according to the invention is advantageous in that a plurality of master holograms may be exposed in a single series and great flexibility in the exposure method is provided at the same time. A large hologram may be formed from a plurality of smaller motifs as a result of providing a multiplicity of master elements and the arrangement thereof, for example in a linear arrangement. These may be part of a larger image or occur as an independent component. In addition to that or in an alternative, the master elements may represent individual holograms that are intended to be separated after the copying.

The complexity of a system may be reduced by using a plurality of relatively small master elements to cover an area that is normally covered by a single large master element. Minor changes or defects of one master element do not necessitate the exchange of all elements. Moreover, the master elements may have a smaller design. This significantly reduces the costs of producing and using the master elements. For example, the transparent substrates that are used to accommodate the master holograms may thus be prepared and polished more easily. This moreover offers advantages in respect of the master element quality since polishing apparatuses for the used materials often have a maximum size restriction. Limiting the dimensions of the master element allows a high polishing grade to be ensured using simple means. The transport and storage of smaller and lighter master elements is also more economical as these may be stacked in space-saving fashion, transported without specific lifting apparatuses and easily inserted into or taken from a replication apparatus.

Furthermore, the method according to the invention allows optimal exploitation of the material of the light-sensitive composite web. By preference, the carrier means may extend over the entire width of the composite web such that the master holograms may be replicated over the entire width of the composite web in regions of the latter. The provision of separate master elements in a carrier means in this case advantageously moreover allows optical separation of the individual master elements from one another in order to avoid stray light during the exposure procedure. To this end, side faces of the master elements may be provided with a light-absorbing layer, for example. Likewise, the carrier means itself may provide light-absorbing spacers. The provision of separate master elements consequently allows a string of measures to enable significantly denser positioning of master holograms without the precision or quality of the replication suffering.

Moreover, a pool of various components may be provided by the provision of a multiplicity of such master elements. The selection of master elements from such a multiplicity enables the reproduction of a diverse spectrum of various combinations of components on a single light-sensitive material. This offers great flexibility in the combination of components so as to create a great variety of images, patterns or texts, wherein the costs are significantly lowered in comparison with digitally controlled individual holography. Figuratively speaking, an individual holography may be compared to writing by hand while the selection of the master elements from the multiplicity of master elements exploits a more economical type case principle analogous to a Gutenberg press.

By selecting the master elements from the multiplicity of master elements according to a sequence, it is possible to produce individual holograms only in the number and order desired by the consumer. This is particularly useful in industries that use a sequenced part delivery (SPD) or a just-in-sequence (JIS) delivery method for parts and advantageously allows the integration of the method according to the invention in such factories. Using the automotive industry as an example, which trends more in the direction of customizability and integrates more HOEs in the construction of automobiles, the replicated holograms may be supplied in a sequence that is harmonized with that of the automobile production sequence. Logistical intermediate steps may thus be dispensed with, increasing efficiency. Moreover, there is less waste since only the exactly required number are produced. For similar reasons, the method according to the invention is also suitable for high-security applications such as banknotes and identity documents.

Furthermore, the carrier means advantageously allows placement of the individual master elements in the apparatus such that they are at fixed, known distances from one another. This ensures great precision during placement, which allows separation of the replicated holograms over the further course of the process if required. In a preferred embodiment of the invention, the master elements are in a linear arrangement in the first carrier means.

The carrier means also allows such precise placement of the master elements that their surfaces are flush with one another and with the carrier means. Thus, the multiplicity of master elements may also be used in the event of thin, flexible, light-sensitive materials without damaging the latter. In this respect, this represents a rejection of previous opinions according to which the use in a single iteration of a plurality of master elements arranged next to one another would lead to edges or projections leading to wear or damage on a moving composite web made of light-sensitive material.

By contrast, on account of the aligned horizontal surface that arises due to the combination of the master elements with the carrier means, it is possible to laminate a light-sensitive material on the master elements with high precision and only low shearing forces.

The lamination brings the light-sensitive material into mechanical contact with the master elements and ensures sufficient optical contact with the master holograms. Particularly homogenous contact between master element and light-sensitive material, which effectively avoids bubbles or folds, may be established as a result of laminating rather than simply placing the light-sensitive material on the master elements. As a result of using a composite web made of the light-sensitive material, this may be efficiently implemented repeatedly over the arrangement of the master elements, and so the composite web moves while the arrangement of the master elements preferably remains stationary. A detachable lamination in particular allows the composite web to be removed without damage or residues and allows it to run on over further stations in a production line.

By virtue of the carrier means being constructed such that at least two faces of each master element are kept optically accessible, one and the same iteration of the method may comprise the exposure of both reflection holograms and transmission holograms. For example, a first master element may be exposed from above on its upper horizontal face such that the light passes through the light-sensitive composite web, is reflected off the master hologram and passes through the light-sensitive composite web again. This would create a reflection hologram. A second master element may be exposed from the side or from below such that the light passes through the master hologram and subsequently passes through the light-sensitive composite web, and a transmission hologram is created. Hence, the method allows greater flexibility in the production of various holograms with different properties in one and the same iteration.

A “sequence” within the meaning of the invention preferably refers to a plurality of elements in a particular order. The elements in the sequence may be identical and repeat or vary. The order is preferably predetermined.

An “arrangement” within the meaning of the invention is preferably a physical positioning of elements at predetermined positions, preferably according to a predetermined order. By preference, the arrangement of the master elements is a linear arrangement.

A “linear arrangement” within the meaning of the invention is preferably a physical positioning of elements such that they form a line along one of their edges, along their center and/or along another reference point. By preference, the “linear arrangement” may comprise a plurality of lines which form rows and columns, for example.

A “carrier means” within the meaning of the invention is preferably a means that holds a plurality of elements such that their positions to one another are affixed. By preference, the carrier means comprises a frame, a framework and/or a plurality of clamps, wherein the clamps may relate to a common mechanical reference, for example a rail. By preference, the carrier means comprises gaps and/or recesses that are designed such that they fit precisely one master element.

A “lamination” or “laminating” within the meaning of the invention is preferably a method of joining between two components. The lamination is preferably designed such that the composite web covers an area in such a way throughout that there are no gaps, bubbles or folds. By preference, the lamination is implemented by means of a lamination roller. In this case, the lamination is preferably implemented at room temperature, for example at a temperature of 20° C.-25° C. However, the lamination roller may optionally be heated to 20-300° C., preferably 20-100° C. or 40-80° C. By preference, the temperature of the lamination roller may be set such that the composite web softens but does not melt. The lamination is preferably designed such that no permanent bond is established between the composite web and the master elements or the carrier means. The lamination may also be implemented with the aid of auxiliaries such as an adhesive, wherein the adhesive is preferably so weak that the parts may be separated from one another with a force of less than 10 N, preferably less than 5 N. By preference, the adhesive is easy to clean, e.g. due to solubility in water, and leaves no residues on the composite web. More preferably, the adhesive evaporates without residue at room temperature.

A “composite” within the meaning of the invention is preferably a multilayered material consisting of two or more different components having different physical properties, which are bonded to one another at an interface. Preferably, the bond between the individual components is constituted such that it is not separable by slight force influence and is therefore deemed to be permanent. The composite may consist of a light-sensitive liquid, a solid or a resin, for example, which are enclosed between two transparent carrier films. In an alternative to that or in addition, the composite web may comprise a stack of layers that are each light-sensitive for different spectral ranges.

A “composite web” within the meaning of the invention is preferably a composite material having a length that is at least double, preferably at least five times, and even more preferably at least twenty times, its width. The thickness of the composite web is preferably set such that it has a certain flexibility, enabling it to be partly wound around a roller, for example. Preferably, the composite web has a thickness of up to 300 μm. The composite web comprises a light-sensitive material. Preferably, the composite web encloses the light-sensitive material between two transparent carrier films having a refractive index similar to that of the light-sensitive material. Preferably, the refractive index of the carrier films and of the light-sensitive material is between 1.4 and 1.6. The light-sensitive material may be for example a light-sensitive photopolymer or a dichromated gelatin. The light-sensitive material may be light-sensitive or wavelength-selective for the entire visible spectrum.

An “exposure” within the meaning of the invention should preferably be understood to mean the targeted steering of electromagnetic beams to an appropriately sensitive surface, preferably for the formation of a hologram. Different methods of exposing a hologram are known; these include transmissive or reflective techniques for producing volume holograms. Examples thereof will be explained in detail below within this document.

A “master element” is preferably a three-dimensional unit which comprises a master hologram in a form that facilitates the handling and moveability thereof. In particular, the master hologram is encompassed by the master element in such a positionally secured fashion that a movement of the master element leads directly to a corresponding movement of the master hologram. By preference, the master element has a length and a width approximately corresponding to those of the master hologram. By preference, the height of the master element is at least double, preferably five times, and particularly preferably at least twenty times, the height of the master hologram. The master element preferably has a regular shape, enabling a mosaic-like or linear arrangement.

The master element comprises a substrate body, which either encloses or carries the master hologram. In embodiments, the master element may comprise for example a transparent upper cover for protecting a master hologram present between the cover and the substrate body. By preference, the upper cover has a refractive index that has been chosen so that light is passed through it, the master hologram and the substrate body without being substantially reflected at the interfaces between the substrate body, master hologram or cover. The upper cover may be for example a transparent film or a glass layer. By preference, the materials of the substrate body, the master hologram and the cover are selected such that the refractive index differences between the individual layers are small. This allows internal reflections to be avoided.

By preference, the “width” relates to a dimension in a horizontal plane transversely to a composite web direction of travel. By preference, the “length” relates to a dimension in a horizontal plane along a composite web direction of travel. By preference, the “height” relates to a dimension in a vertical plane that is orthogonal to the plane formed by the width and the length.

A “substrate body” within the meaning of the invention is preferably a three-dimensional material block that carries or encloses the master hologram. Preferably, the substrate body is transparent. The substrate body preferably has a plurality of faces, including an upper face which may be aligned horizontally.

Within the meaning of the invention, the term “transparent” or “transparency” preferably relates to a property of a material whereby it is substantially transmissive to light. Preferably, a transparent material within the meaning of the invention is transmissive at least to part of the electromagnetic spectrum, preferably with a wavelength of between 100 nm-1 mm, particularly preferably between 400 nm-780 nm. Particularly preferably, a transparent material, for example a transparent substrate body, is transmissive to light in a wavelength range with which an exposure of the master holograms is effected. A transparent material may also be colored in such a way that it selects the light radiation of a specific wavelength.

A “master hologram” within the meaning of the invention is preferably a holographic optical element comprising at least one hologram to be replicated. The master hologram is designed for an optical function (e.g. diffraction, reflection, transmission and/or refraction) for one or more wavelengths. For this purpose, for example, a plurality of holograms, each of which e.g. diffracts light at one wavelength, and/or multiplex holograms, which diffract light at a plurality of wavelengths, may be arranged as hologram stacks. The master hologram may be a diffractive optical element (DOE), for example. Diffractive optical elements (DOEs) use a surface relief profile with a microstructure for their optical function. In an alternative, the microstructure may also be present in the volume of the element in the form of a local difference in refractive index. The light transmitted by a DOE may be converted into almost any desired distribution by diffraction and subsequent propagation. This may involve an image, a logo, a text, a light refraction pattern or the like. Moreover, the master hologram may be a technical hologram, for example a Bragg mirror, a diffuser or a hologram acting as a lens.

The process for producing the master hologram may preferably be referred to as “hologram origination” or “hologram mastering”. The master hologram may be created by an analog or a digital method. In one exemplary analog method, a first coherent beam, the object beam, is reflected off an object onto a recording material, which is simultaneously subjected to a second coherent beam, the reference beam. The object beam and the reference beam interfere and create an interference pattern on the recording material. This interference pattern or stripe pattern is recorded by light-sensitive material and, following the processing, assumes the form of a surface relief pattern on a surface of the material or the form of spatially varying refractive indices only a few micrometers under the surface. In order to view an image of the original object, the master hologram may be illuminated with light that is diffracted by the recorded surface relief pattern or refractive index pattern. This diffracted beam contains the image of the original object. The master hologram can then be used as a new object when creating further copies with the same image.

The master hologram may preferably also be computer-generated. The microscopic gratings which generate the diffraction effects may be produced e.g. by laser interference lithography. In this technique, two or more coherent light beams are configured such that they interfere at the surface of a recording material. The positions of the light beams with respect to the recording material may be controlled by a computer. Depending on the intensity of the laser, the recording material may consist of almost any material. Other techniques such as electron beam lithography may likewise be used for the digital production of the master hologram. The master hologram may preferably comprise glass, silicon, quartz, UV lacquer, a photopolymer composite and/or a metal such as nickel.

An “optically accessible face” within the meaning of the invention is a face, at least 50% of which, preferably at least 60%, 70%, 80% or 90% of which and particularly preferably 100% of which is not covered by an optically absorbing material. In particular, there is no optically absorbing material present between the relevant surface and a light source serving the exposure.

Depending on the shape of the master element, an opaque frame of the carrier means may cover a part of the optically accessible surface in some cases. By preference, the frame does not cover more than 50% of the optically accessible face, and preferably no more than 40%, 30%, 20% or 10%. By preference, an optically accessible face is also not very reflective. It may be preferable for the optically accessible face to have a reflectance of less than 50%, preferably less than 40%, less than 30%, less than 20% or less than 10%, for visible light at a normal angle of incidence. In some preferred embodiments, an optically accessible face comprises an antireflective coating (AR coating). This may increase the utilization of the incident light for the exposure of the composite web.

In a preferred embodiment of the invention, the master elements are separated along a linear arrangement in the first carrier means. Consequently, the carrier means may preferably form a buffer spacing between adjacent master elements. The buffer spacing advantageously prevents an unwanted propagation or scattering of light from one master element to an adjacent master element from impairing the replicated hologram. At the same time, the spacing may facilitate handling of the replicated holograms. Firstly, the respective holograms can be separated more easily. Secondly, a small edge around the hologram may remain free even after a cutting apart, said small edge allowing the hologram to be transported without contact with the image content. The risk of damage to the fully replicated holograms is reduced, and the quality is increased.

By preference, the master elements are separated by light-absorbing spacers. This protects the master holograms and the part of the composite web located thereon from stray light or from light used to expose an adjacent master hologram. Should unwanted light reach the wrong regions of the composite web, the latter may be exposed with unwanted patterns that are superimposed on the replicated image and reduce the quality of the latter. Provided a first master element is exposed by light directed on its side face without a light-absorbing barrier being present, the light may for example reach a second master element arranged next to the first in a row. In this way, the second master element may be exposed from an unsuitable angle, whereby an unintended ghost image is created on the relevant part of the composite web. This phenomenon is referred to as “crosstalk” and is particularly effectively prevented by the use of light-absorbing spacers.

Moreover, integration of the light-absorbing spacer in the carrier means allows the outwardly directed side faces and the top side of the master elements to be kept optically accessible. Furthermore, the substrate body of the master elements may be advantageously kept completely transparent on all sides. This is particularly advantageous for allowing an exposure from different orientations, for example for transmission or reflection, optionally in an edge-lit or back-lit configuration.

In an alternative to that or in addition, the application of a light-absorbing layer to vertical faces of the master elements may be preferable. A light-absorbing layer may be much thinner than a spacer of the carrier means. Thus, a plurality of master elements may be exposed next to one another without optical disturbances arising, while a minimal buffer spacing or a virtually continuous effect in a replicated hologram made up of a plurality of components of the various master holograms is maintained at the same time.

Advantageously, this enables a virtually seamlessly replicated (overall) hologram with large dimensions and a high image quality without requiring the use of a master element of the same size. Moreover, small changes can be made to a part of the hologram without necessitating an exchange of all master elements. For example, a region of an (overall) hologram to be replicated that should be modified between the iterations may relate to the (local) language of a text element used in a head-up display in the automobile. In a further example, the required arrangement or alignment of the master elements may also vary depending on whether this is a head-up display for a left-hand drive or right-hand drive vehicle of the same model. By exploiting a type case principle, in which individual master elements can be exchanged accordingly in a simple manner, the method according to the invention enables the quick and cost-effective implementation of such adaptations.

By preference, a thickness of the light-absorbing layer is up to 5 mm, preferably up to 3 mm and more preferably up to 1 mm, and/or by preference at least 10 μm, preferably at least 100 μm and particularly preferably at least 500 μm.

By preference, the first carrier means is mounted so as to be inclinable and/or height-adjustable, wherein the apparatus for replicating the master holograms preferably comprises means for setting an inclination angle and/or adjusting the height of the first carrier means. Within the meaning of the invention, such means may also be referred to as an alignment unit for the first carrier means and are known to a person skilled in the art. Exemplary means for setting a height adjustment of the first carrier means comprise an adjustment table with actuators for upward and downward movement. Thus, the first carrier means and the master elements contained therein may be brought into contact with a further process component, in particular a composite web, an optical adhesive film, a lamination roller and/or one or more input coupling elements.

Means for setting an inclination angle may preferably likewise comprise an adjustment table, in which an inclination angle of the first carrier means, for example in relation to a plane of the composite web, may be set by means of appropriate actuators. Advantageously, this may ensure a particularly plane-parallel alignment of the master elements situated within the first carrier means with respect to the composite web or input coupling elements (described hereinafter). In this case, the rotation of the entire first carrier means allows a uniform alignment of the master elements.

In this case, the means for setting an inclination angle and/or adjusting the height of the first carrier means preferably allow a fine adjustment with a height adjustment accuracy of at least 10 μm, preferably at least 5 μm, and/or allow a setting of the inclination angle with an accuracy of at least 0.1°, preferably at least 0.01°.

In an alternative to that or in addition, the further process components are mounted in height-adjustable fashion in order to establish sufficient contact between the process components to perform the replication method. The further process components may include: transport rollers or transport components for positioning the composite web, possible input coupling elements, a lamination roller, a dosing unit for applying an optical liquid or a roller for applying an optical adhesive film. These components are explained in more detail hereinafter. The height adjustability of the process components preferably allows a fine adjustment of their positions with a height adjustment accuracy of at least 10 μm, preferably at least 5 μm.

In a preferred embodiment, the first carrier means is cushioned. The cushioning may have an active or passive configuration and is preferably designed to tolerate an upward and downward movement of the first carrier means. The cushioning is preferably implemented mechanically, (electro) magnetically, hydraulically or pneumatically, with a pneumatic cushioning being particularly preferred. By preference, the cushioning is configured for a height adjustment of at least 20 μm, preferably at least 50 μm and particularly preferably at least 100 μm, and/or of at most 1000 μm, by preference at most 500 μm and particularly preferably at most 200 μm.

By preference, the cushioning of the first carrier means is pressure regulated, in particular in order to establish and maintain a preferred pressure between the lamination roller and the respective master elements. The cushioning of the first carrier means preferably allows for the first carrier means to be brought into contact with a further process component, with all tolerances in the level of the surface of the master elements being compensated for at the same time. Advantageously, the provision of a cushioned first carrier element may during the replication process also compensate for possible height differences between individual master elements situated within the first carrier means. An oblique position of the first carrier means may likewise be compensated for. As explained in more detail hereinafter, it may for example be preferable to use a lamination roller to apply a composite web to the master elements. For this purpose, the lamination roller preferably sweeps over the composite web and master elements therebelow in succession, wherein optimal height or pressure conditions are set for each of the swept-over master elements by means of the cushioning of the first carrier means. For example, the first carrier means may also move slightly upward and downward synchronously with the lamination roller as a result of the cushioning, in order to compensate for height differences between the master elements. As a result, all master elements can be brought exactly to the required height.

It is also possible to compensate for production tolerances or damage to the surface of the master elements. Air gaps or bubbles between the surface of the master elements and the composite web and/or the input coupling element are eliminated, and the optical contact between the master elements and further process components is improved.

In a further preferred embodiment of the invention, the master elements are positionable in cushioned fashion in the first carrier means. Thus, the first carrier means may preferably also comprise means for cushioning the master elements on an individual basis, in particular independently of one another. For example, a base of the first carrier means may be provided with an elastic material, for example a foam.

This may compensate for variations in the dimensions of the master elements within the first carrier means, for example such that the composite web may be clamped without gaps between planar input coupling elements and the master elements.

In a preferred embodiment of the invention, the method further comprises the arrangement of one or more optically transparent input coupling elements on the laminated composite web such that a partial section of the composite web is trapped between the one or more input coupling elements and the master elements during the exposure.

Within the meaning of the invention, an “input coupling element” is preferably a three-dimensional block made of transparent material which has a refractive index and dimensions configured such that they direct the exposure beams to the master holograms and/or guide said exposure beams away from said master holograms. By preference, the input coupling element may have any desired three-dimensional shape, in particular a parallelepipedal shape, a wedge shape, a cylindrical shape, a prismatic shape and/or a prismatic shape with a semicircular or semi-elliptical cross section. By preference, the input coupling element may have various optically accessible faces. By preference, at least one side face or base and a lower side or lateral face of the input coupling element are optically accessible. By preference, an optically accessible face of the input coupling element is also not very reflective. It may be preferable for the optically accessible face to have a reflectance of less than 50%, preferably less than 40%, less than 30%, less than 20% or less than 10%, for visible light at a normal angle of incidence. In some preferred embodiments, an optically accessible face comprises an antireflective coating (AR coating). This may increase the utilization of the incident light for the exposure of the composite web.

The input coupling element may be used to direct an exposure beam on a side face above a master hologram. The angle of the exposure beam may be chosen such that the latter additionally passes through a lower face of the input coupling element and reaches the master hologram before it is reflected back through the composite web. By way of the input coupling element, the reflected light is steered in such a way that it is not incident on adjacent parts of the composite web and its scattering is minimized. Alternatively, the light may also be guided through the master hologram in order to expose a transmission hologram in the composite web.

The input coupling element may also serve to secure the composite web above the surface of the master elements. Since the input coupling element need not be exchanged between the series, it is possible to use a single plate that covers all linearly arranged master elements in the carrier means. As a result, there is no risk of edges of the input coupling elements being able to leave traces on the composite web. Moreover, the alignment of the input coupling element above the carrier means is facilitated.

However, the use of a plurality of input coupling elements may be preferred. This reduces the size and weight of each input coupling element and facilitates storage and exchange. This moreover offers advantages in respect of the input coupling element quality since polishing apparatuses for the used materials often have a maximum size restriction. A high polishing grade can be attained by virtue of limiting the dimensions of the input coupling element in this way.

It may be particularly advantageous for a contact face of the input coupling elements with the composite web to have the same length and width as a contact face of the master elements with the composite web, and for these contact faces to be arranged immediately opposite one another. This allows a precise assignment of the two elements to one another and, should the input coupling elements leave prints or traces on the composite web, these prints or traces would be situated in the buffer region between replicated holograms. In preferred embodiments, the input coupling elements and master elements may have an identical substrate body in terms of size and shape. In this way, the substrate bodies can be produced and stored more cost-effectively in larger numbers.

A respective input coupling element is assigned to each master element in a further preferred embodiment of the invention. By preference, at least a lower face of the respective input coupling element is congruent with an upper face of the corresponding master element.

In a further preferred embodiment of the invention, the input coupling elements are arranged on a height-adjustable second carrier means. The second carrier means may be configured analogously to the first carrier means. In particular, the second carrier means—in a manner analogous to preferred embodiments of the first carrier means—is mounted in inclinable and/or height-adjustable fashion. Likewise, cushioning of the upward and downward movement of the second carrier means may be preferred. It may be preferable for the second carrier means to comprise light-absorbing spacers between the input coupling elements. This may prevent the light beams from reaching adjacent input coupling elements or being reflected into adjacent parts of the composite web.

The height-adjustable second carrier means may be used to bring the input coupling elements into contact with the composite web, preferably following a lamination of the composite web and prior to the exposure thereof.

In this case, it may be preferable for the lamination to be implemented in the same stretch of the composite web as the exposure. During the lamination, the second carrier means with the input coupling elements may be kept at a distance from the composite web (first height). The composite web may be laminated with the aid of a roller which is lowered onto the composite web and rolls over the composite web in order to bring the latter into tight contact with the aligned horizontal surface of the master elements. The lamination roller and/or the master elements may preferably be cushioned in order to maintain the contact between the two components despite variations in the surface position or surface quality of the components. The lamination roller may subsequently be raised or withdrawn such that the input coupling elements may subsequently be lowered in order to establish contact with the composite web (second height). In the position of the input coupling elements, the composite web is consequently clamped between the input coupling elements and the master elements.

The exposure can be performed both by way of the master elements and by way of the input coupling elements. Once the exposure is complete, the input coupling elements may be raised again to a first height position at a distance. Optional affixation may be implemented in situ, and the composite web may be detached from the surface of the master elements, e.g. by virtue of one or more other rollers raising one or more parts of the composite web, which are located outside of the first carrier means for the master elements, from below. The first carrier means remains accessible, and so the sequence of the master elements may be changed. This allows a plurality of process steps to be performed in a single region. This increases the compactness of the method and of the apparatus used therefor.

In a preferred embodiment of the invention, the same input coupling element is used for the exposure of various master elements. For the exposure, a contact face of the input coupling element may cover the surface of all master elements in the first carrier means in this case. For example, an input coupling element in the form of a parallelepipedal input coupling plate may be used, the length of which extends over all master elements. Alternatively, an input coupling element may be moved over the surface of the master elements, wherein an exposure is preferably implemented in synchronization with the movement of the input coupling element. The movement of the input coupling element may preferably be a pushing or rolling movement.

By preference, the one or more input coupling elements are configured in such a way that only a limited area is in contact with the composite web at any one time during the exposure. By preference, this area is referred to as “contact face” within the meaning of the invention. Especially in the case of an input coupling element that is designed to roll over the composite web, the contact face of the input coupling element may constantly shift while maintaining the same size.

In preferred embodiments of the invention, the contact face of the input coupling element is curved or planar. A lens effect should preferably be avoided if curved contact faces are used. Depending on the application, the use of curved or planar surfaces may be preferred, as explained below.

In a further preferred embodiment of the invention, an input coupling element has a cylindrical shape. By preference, such an input coupling element may act as a roller and may be rolled or pushed over the composite web. Hence, the cylindrical input coupling element may establish optical contact along one axis with the composite web. Light from a lateral face and/or a base may be steered to the composite web and the master elements via the input coupling element. By preference, a light source and/or a light-deflecting component moves synchronously with the input coupling element in order to expose the master elements.

In a further preferred embodiment of the invention, the cylindrical input coupling element is mounted analogously to a lamination roller, wherein the cylindrical input coupling element is preferably mounted in height-changeable, height-adjustable, cushioned and/or pressure-regulated fashion. Such mounting may improve the optical contact between the input coupling element and the composite web and the master elements. By preference, one or more bearing rollers, preferably three bearing rollers, are moreover provided for mounting and/or moving the input coupling element.

In preferred embodiments of the invention, the cylindrical input coupling element itself acts as a lamination roller, or vice versa. Thus, the cylindrical input coupling element may also improve mechanical contact between the composite web and the master elements. In this arrangement, the lamination is preferably implemented synchronously with an exposure. It is possible to manage without a separate lamination roller in this case. This is particularly space-saving and increases the method throughput. A further advantage of using a cylindrical input coupling element lies in the small contact face between the input coupling element and the composite web. Such a small contact face is particularly advantageous when using an optical fluid between the input coupling element and the composite web. Firstly, it is possible to keep the amount of optical fluid used to a minimum. Secondly, the forces required to remove the input coupling element from the composite webs are also reduced. Hence, the cylindrical input coupling element can be removed in a manner that is particularly gentle to the composite web. This is explained in detail in relation to the use of optical fluids.

In a further preferred embodiment of the invention, the input coupling element has a prismatic shape with a semicircular cross section. The shape of such an input coupling element may preferably correspond to the lower half of a roller and may comprise two lateral faces: a curved lateral face and a plane lateral face. By preference, the curved lateral face is brought into contact with the composite web on the surface of the master elements and pushed over this surface. This can keep the weight of the input coupling element to a minimum. Furthermore, the input coupling element has a narrow contact face with the composite web; this is advantageous when using optical fluids. A lens function should preferably be avoided when exposing such an input coupling element.

In a further preferred embodiment of the invention, an input coupling element has a prismatic shape with at least one plane face that preferably serves as contact face for application to the composite web. By preference, the cross section of the input coupling element tapers toward the plane contact face, and so the prismatic shape may also be referred to as wedge shape within the meaning of the invention. For example, the input coupling element or at least one section of the input coupling element may have the shape of an isosceles trapezoid in cross section, wherein the shorter base of the trapezoid, as a plane face, is brought into contact with the composite web. The embodiment allows optimal setting of the contact face between the input coupling element and the composite web; in particular, it may also be chosen to be larger than would be the case for a cylindrical input coupling element, in which case, depending on the size of the curvature, the contact face substantially corresponds to a line. Especially when an optical fluid is used, a larger contact face without friction and gaps may be maintained during the displacement of the input coupling element. Increased capillary forces between the contact element and the composite web advantageously additionally suppress the formation of gaps, and so there is a particularly good optical contact.

In a further preferred embodiment of the invention, contact between the input coupling element and the composite web on the surface of the master elements is implemented with a predetermined pressure. To this end, compression force sensors or pressure sensors are preferably provided for the purpose of measuring a compression force or a pressure between the input coupling element and the master elements. By preference, a film coating can preferably be used as a sensor for the pressure exerted by one process component on another, wherein a pressure sensor is distributed over the totality of a film (a so-called “pressure-measurement film”). Such a pressure-measurement film is preferably applied to a region of the process component not used for the exposure, for example an edge region, and is particularly compact.

In a further preferred embodiment of the invention, a lower face of the input coupling elements is formed by a deformable transparent input coupling section. The use of such a deformable input coupling section is especially preferred in the case of embodiments of the invention in which the input coupling elements are only moved upward and downward in relation to the master elements. By preference, input coupling elements with deformable input coupling sections are neither rolled nor displaced over the surface of the composite web that is in contact with the master elements.

Within the meaning of the invention, an “input coupling section” preferably is a part of the input coupling elements that consists of a transparent deformable material and that is designed such that it ensures complete optical contact between the input coupling element and one or more master elements. By preference, the refractive index of the input coupling section is identical to, or within a range of +/−20%, preferably +/−10% and more preferably +/−5% about, the refractive index of the main body of the input coupling element, the composite web, an upper cover of the master element, the master hologram and/or the substrate body of the master element.

The deformability of the input coupling section allows the latter to be pressed in such a way on the composite web while the composite web is situated on the aligned surface of the master elements that no gaps or bubbles remain. This ensures particularly homogeneous optical contact between the three elements of the sandwich. Unwanted optical aberrations or patterns are avoided, whereby the end product has a higher quality.

In a further preferred embodiment of the invention, a material of the input coupling section is chosen such that it has a shear modulus of at least 10 kPa, preferably of at least 100 kPa and more preferably of at least 1 MPa. It may also be preferable for the material of the input coupling section to have a Young's modulus of between 1 MPa and 50 MPa. It may also be preferable for the material to have a refractive index of between 1.4 and 1.6. In terms of material, silicone was found to be particularly suitable to obtain a sufficient refractive index and simultaneously be sufficiently elastic, easy-to-clean and not leave any residues on the composite web.

In addition to that or in an alternative, it may be preferable for an optical fluid to be applied to the horizontal surface of the master elements and/or of the composite web. Said optical fluid may have a refractive index close to that of the substrate body of the master elements, of the input coupling element and/or of the composite web in order to ensure a disturbance-free transmission of light. Moreover, the optical fluid may improve the optical contact between the elements since possible wedge errors, surface tolerances or damage are compensated for. Air gaps or bubbles between the process components may likewise be filled in order to suppress unwanted reflections at interfaces between the components.

In a further preferred embodiment of the invention, a dosing unit for dosing the optical fluid is provided. The dosing unit is preferably configured to apply a predetermined amount of an optical fluid to a process component. In particular, the dosing unit is preferably configured to apply to the composite web an amount of optical fluid that is sufficient to completely fill a gap between the input coupling element and the composite web.

The dosing unit is mounted in height-adjustable fashion in a further preferred embodiment of the invention. Thus, the dosing unit may be brought into the vicinity of a surface of a process component, e.g. the composite web, for a precise application of the optical fluid and may then be removed in order to create space for further process components such as input coupling elements or light sources.

An optical fluid is introduced between the composite web and an input coupling element in a further preferred embodiment of the invention. The amount of optical fluid used is preferably configured to cover a contact face between the input coupling element and the composite web. By preference, the optical fluid adheres to the surfaces of the input coupling element and the composite web by means of capillary forces. Greater forces are created in the case of larger contact faces between the input coupling element and the composite web. This is advantageous to maintain optical contact during a movement of the input coupling element over the composite web.

By preference, the input coupling element is removed from the composite web post-exposure such that adhesive forces on the composite web are minimized.

In a preferred embodiment of the invention, the input coupling element is moved horizontally in the plane of the composite web-preferably transversely to the direction of travel of the composite web-before the input coupling element is removed from the composite web by way of a vertical movement. Such a movement in the plane of the composite web can be a transverse, oblique or rotational movement. The movement is preferably configured to reduce the contact face between the input coupling element and the composite web without already implementing a vertical movement. This can effectively avoid an unwanted force transmission onto the composite web. It is preferably possible to manage without such a movement for the removal of the input coupling element when an input coupling element with a curved contact face is used—for example when a cylindrical input coupling element is used-since the narrower contact face reduces the risk of a deformation or distortion of the composite web.

An optical adhesive film is temporarily introduced between two process components of the method in a further preferred embodiment of the invention. For example, the optical adhesive film may be introduced between a master element and the composite web and/or between the composite web and an input coupling element.

Within the meaning of the invention, an “optical adhesive film” preferably is a transparent film with a refractive index close to the refractive index of the master element, of the composite web and/or of the input coupling element. The optical adhesive film is preferably configured to improve optical contact between two exposed process components such that reflections at the interface between the process components are reduced or eliminated.

By preference, the materials used for the optical adhesive film have identical or similar optical properties to those materials used for the substrate of the master element (or of the input coupling element or its input coupling section) and/or the composite web. By preference, the similar or identical properties comprise transparency, haze, stress birefringence properties and/or the refractive index. The use of identical or similar materials allows very close matching of the optical adhesive film refractive index to the refractive indices of the adjacent process components, and so it is possible to ensure a transition between the adjacent refractive indices without refractive index jumps. This largely eliminates or significantly reduces reflections at the interface between the master element (or the input coupling element), the optical adhesive film and/or the light-sensitive composite web.

In a preferred embodiment of the invention, a refractive index difference between the surface (or a cover) of the master element and the optical adhesive film and/or between the optical adhesive film and a surface of the light-sensitive composite web is no more than 0.2, preferably no more than 0.1 and more preferably no more than 0.05. Likewise, in the case in which the optical adhesive film is introduced between the light-sensitive composite web and an input coupling element, the difference between the refractive index of the optical adhesive film and an adjacent surface of the input coupling element is preferably no more than 0.2, more preferably no more than 0.1 and more preferably no more than 0.05.

In a further preferred embodiment of the invention, a refractive index of the optical adhesive film is between the refractive index of the surface of the master element and the refractive index of a surface of the light-sensitive composite web. Should the optical adhesive film be arranged between the light-sensitive composite web and an input coupling element, the refractive index of the optical adhesive film is preferably between that of the light-sensitive composite web and that of the input coupling element. In this context, the term “between” preferably also includes the values of the refractive indices of the adjacent process components themselves. This arrangement allows a smooth or disturbance-free transition of light beams between the various process components, with minimal reflections and/or aberrations at interfaces.

Furthermore, the optical adhesive film is preferably a solid in which Brownian motion of the molecules is sufficiently small, whereby a “wobble” of the phase of the light is prevented; this thus yields a more stable interference field in the hologram copy within the exposure time. In this way, the microstructures do not smear, whereby the diffraction efficiency of the holograms is maximized. The sharpness and the contrast of the created hologram are also substantially improved. The optical adhesive film improves the optical contact between exposed transparent components, through which the exposure light is guided. This reduces unwanted reflections, scattering or losses, and the quality of the reproduced hologram is increased.

The optical adhesive film may be formed in a manner analogous to the composite web and may be moved through the process in analogous fashion, e.g. with the aid of rollers. This enables simple synchronization of the optical adhesive film with the composite web. It is also possible and may be preferable that the optical adhesive film and/or the light-sensitive composite web is applied to the surface of the master element or the surface of the input coupling element by a lamination roller. In this case, the same roller may be used for the lamination of the composite web and the optically adhesive film.

In contrast to the OCAs (optical clearance adhesives) known from the field of optical displays, the optical adhesive film preferably has a low adhesive power in addition to its advantageous optical properties. As a result, after use the optical adhesive film can be removed from a surface without residue and with little force.

In a preferred embodiment of the invention, the optical adhesive film comprises at least one adhesive layer. The at least one adhesive layer preferably has a peel force vis-à-vis the surface of the master element and/or of the input coupling element and/or a surface of the light-sensitive composite web of less than 3 N/cm (newtons per centimeter), preferably of less than 1 N/cm.

However, in preferred embodiments, the peel force of the adhesive layer of the optical adhesive film vis-à-vis the surface of the master element and/or of the input coupling element and/or a surface of the light-sensitive composite web is at least 0.01 N/cm, preferably at least 0.1 N/cm. For example, the peel force of the optical adhesive film or one of its layers may be measured according to a 180 degrees peel test. In preferred embodiments, the measurement is implemented pursuant to ASTM D903.

In a preferred embodiment of the invention, the optical adhesive film has a single-layer layer structure, wherein the layer structure comprises exactly one adhesive layer. The exactly one adhesive layer is preferably adhesive on both sides in order to impart an optical contact.

In a preferred embodiment of the invention, the optical adhesive film comprises two adhesive layers, wherein each adhesive layer is preferably applied directly to a carrier layer such that the optical adhesive film comprises three layers. Such an optical adhesive film may adhere to two surfaces simultaneously, whereby particularly good optical contact may be imparted, and a risk of air gaps or unwanted reflections is reduced.

In a preferred embodiment, the method is performed with the aid of an apparatus, wherein the apparatus comprises an unwinding roller for unwinding the optical adhesive film and a rewinding roller for rewinding the optical adhesive film after use. By preference, the method comprises a step of removing the optical adhesive film from the relevant process component post-exposure. By preference, the apparatus moreover comprises a lamination roller for temporarily laminating the optical adhesive film to the surface of a master element, of a composite web and/or of an input coupling element. By preference, the optical adhesive film may be provided with protective layers on one or both sides. The apparatus may comprise rewinding rollers for removing the protective layers before the optical adhesive film is used.

In a further preferred embodiment of the invention, the first carrier means is designed such that master elements of different shapes and/or sizes may be arranged therein. Thus, for example, one or more frame elements and/or spacers of the carrier means may be arranged in displaceable and/or clampable fashion. The first carrier means may also be designed such that it is able to accommodate master elements of different thicknesses. Filler substrate blocks may be affixed below one or more master elements in order to bring the top sides of the master elements to the same level.

In a further preferred embodiment of the invention, the substrate bodies of the master elements have the same dimensions. By preference, the substrate bodies have a parallelepipedal shape. The use of identical square shapes for the master elements was found to allow particularly simple alignment of the master elements in the first carrier means. However, the use of different shapes is likewise also possible, with the shapes or dimensions varying along the film web in particular. Different shapes of the substrates of the master elements are also possible perpendicular to the film web; however, this is less preferred in view of a lesser material use.

In a further preferred embodiment of the invention, the substrate bodies preferably have a height of between 1-10 cm, a length of between 3-20 cm and a width of between 3-20 cm.

While the method according to the invention may use master elements of any desired dimensions as a matter of principle, a height of at least 1 cm was found to be preferable so that a sufficient area is available for exposure on the side of the master elements. The preferred heights moreover easily allow an exposure from different angles in order to meet different requirements for the replication of the holograms. Furthermore, the preferred dimensions ensure sufficient robustness with a compact size, in order to allow simple exchange. The lengths and/or widths of at least 3 cm specified as preferable moreover allow a sufficiently economic use of the composite web, especially when a buffer spacing is present between the master elements. Moreover, the dimensions are suitable for capturing the image or pattern to be copied for applications such as printing banknotes. Even though lengths and/or widths of the substrate bodies are likewise unlimited, substrate bodies with a length and/or width of up to 20 cm allow the production costs to be lowered and allow for particular ease of handling.

In a further preferred embodiment of the invention, the at least two optically accessible faces of the master elements are polished, wherein the polishing grade is preferably at least P3. In a further preferred embodiment of the invention, the optically accessible faces of the input coupling elements are also polished, wherein the polishing grade is preferably also at least P3.

It is advantageous for both surfaces to be polished if a surface of the input coupling element is brought against a surface of the master element via the composite web. It is moreover furthermore preferable for a wedge error of the master elements and/or the input coupling elements to be largely reduced, both on an individual basis and with respect to one another. In the event of an unwanted wedge, the planar optical contact could be impaired by a parallel shift of the input coupling elements in relation to the master elements.

In a further preferred embodiment of the invention, the substrate bodies of the master elements are formed from a material which is an optical plastic. By preference, the material of the substrate bodies is selected from the following group: polymethylmethacrylate (PMMA), polycarbonate (PC), cycloolefin polymers (COP), cycloolefin copolymers (COC) and/or an optical glass, preferably selected from the group comprising borosilicate glass, quartz glass, B270, N-BK7, N-SF2, P-SF68, P-SK57Q1, P-SK58A and/or P-BK7.

Preferably, both the substrate body and a possible cover of the master element have a refractive index of between 1.4 and 1.6.

The selection of the material for the substrate body may depend on the desired exposure angle, possible restrictions of the height and the desired refractive index resulting therefrom. It may additionally be preferred for a substrate body to be colored in order for example to filter light based on a wavelength selection in order to create a hologram with a specific wavelength. In this way, it is possible to use a broadband light source for the exposure of different master holograms.

In a further preferred embodiment of the method, a selection and, optionally, the arrangement of the sequence of the master elements are controlled by a control unit.

By preference, the term “control unit” relates to any desired computer unit having a processor, a processor chip, a microprocessor or a microcontroller allowing automated control of the components of the apparatus, e.g. a rotational speed of an unwinding roll, rewinding roll, lamination roller, transport roller, the movements of a pick-and-place robot for the master elements, of an alignment unit for the master elements or of the carrier means, a lamination temperature, a lamination pressure, an orientation and/or scanning speed of a light source, a wavelength of the light source, an affixation intensity, etc. The components of the control unit may be configured conventionally or on an individual basis for the respective implementation.

By preference, the control unit comprises a processor, a memory and a computer code (software/firmware) for controlling the components of the apparatus.

The control unit may also comprise a programmable printed circuit board, a microcontroller or any other apparatus for receiving and processing data signals from the components of the apparatus, for example from sensors in relation to the identity or type of a master element, and other relevant sensor-based information. The control unit preferably furthermore comprises a computer-usable or computer-readable medium, such as a hard disk, a random access memory (RAM), a read only memory (ROM), a flash memory, etc., on which computer software or a code is installed. The computer code or the software for controlling the components of the device may be written in any desired programming language or model-based development environment, such as e.g. C/C++, C#, Objective-C, Java, Basic/VisualBasic, MATLAB, Python, Simulink, StateFlow, Lab View or assembler, without being restricted thereto.

The phrase “the control unit is configured to” carry out a specific method step, e.g. the exposure of a master element at a specific angle by virtue of modifying the speed of one or more drive motors, may comprise customer-specific or standard software which is installed on the control unit and which initiates and controls these operational steps.

By preference, the control unit comprises a processor and a memory. By preference, the processor reads sequence data from the memory and signals to an actuator and/or a user the sequence in which the master elements should be arranged. Thus, the control unit can preferably ensure that the master holograms are arranged in the first carrier means according to a predetermined order, for example an order in which relatively large components that integrate the replicated holograms therein are processed on a parallel manufacturing line.

It may be advantageous for the control unit to instruct an actuator to bring the next master element or the next n master elements in the order closer to or into the first carrier means, where n is preferably the number of master elements that the first carrier means is able to accommodate. By preference, the actuator may be a logistics dolly, any other conveyor belt, a rotary table or a pick-and-place robot, to name but a few examples. In this way, placement of the master elements in the correct order may be partially or fully automated, with the risk of human errors being reduced.

It may also be preferable for the control unit to be configured to signal to a user the next master element or the next n master elements. This may be implemented in different ways, e.g. visually or acoustically. As an example of a visual signal, the control unit may be configured to activate a light at the storage location of the next master element, e.g. at the corresponding shelf, box, trolley, etc.

By preference, the control unit comprises an interface for signaling the sequence to a user. Thus, the processor may be configured to read sequence data from the memory and instruct the interface, e.g. a monitor, to display all of the sequence data or a relevant part thereof. By preference, the sequence data may comprise information regarding the following:
the identities or types of the master elements to be exposed and their order,
a matrix arrangement of the master elements in the first carrier means, for example a line or column number,
one or more wavelengths intended to be used to expose the master element,
a luminous intensity intended to be used to expose the master element,
the angle from which the master element is intended to be exposed, and/or the angle position and the path of the light source,
the type of hologram to be created, for example a reflection hologram or transmission hologram.

This list is neither exhaustive nor exclusive but merely exemplary.

In a further preferred embodiment of the invention, exposure instructions for the sequence are stored in the memory. By preference, the processor signals to a user and/or an actuator to set the position, the path and/or the wavelength of a light source in accordance with the exposure instructions. By preference, the control unit comprises an interface for signaling the exposure instructions to a user.

In a preferred embodiment of the invention, the control unit is connected to a sensor, wherein the sensor preferably reads an ID feature of the individual master elements or of a storage location of the master elements and transmits the ID to the control unit for the purpose of controlling and/or monitoring the sequential arrangement.

Within the meaning of the invention, an “ID feature” preferably relates to the entire master hologram itself or a part thereof, or alternatively relates to a QR code, a barcode, a number, a symbol or the like, which may be permanently or removably affixed to the master element for the purpose of identifying the latter. In addition to that or in an alternative, the ID feature might not be situated on the master element but on its storage location instead. By preference, the ID feature is affixed to a region of the master element which does not cross the path of a light beam used for exposure purposes. By preference, this region is situated on a different surface of the master element to the at least two optically accessible surfaces.

By controlling or monitoring the identities of the master elements placed and exposed in the first carrier means, the control unit is able to prevent and/or recognize errors in the sequence. By preference, the control unit is moreover able to draw a user's attention to such errors such that there may be a corrective intervention in the production procedure. A further advantage consists of the fact that a register of exposed holograms may be created and stored in the memory. The latter may be used for quality control and for statistical purposes. The control unit may also use this information to determine which master elements need to be serviced or replaced. Thus, e.g. depending on the number of uses, optionally weighted by the intensity of an exposure, corresponding master elements may be replaced before a degradation of the master elements leads to a loss of quality.

In a preferred embodiment of the invention, the method comprises an arrangement of the master elements in two parallel rows. By using at least two rows, the size of the master elements can be reduced even further while simultaneously exploiting the entire width of the composite web in an optimal fashion. To the extent changes are required in a partial region of a larger master hologram to be replicated, these changes can also be implemented with smaller parts. Moreover, the efficiency of the method may also be improved since a greater number of identical or different master holograms can be replicated at the same time.

With a sufficient luminous intensity, it is possible to expose both rows from an optically accessible side of the master elements. That is to say, the light beam directed into the side face of a master element in a first row may reach a master element in the second row, which in the beam direction is located behind said master element in the first row. This further increases the efficiency of the process since two master holograms may be replicated simultaneously by means of one light source.

Likewise, it may be preferable to expose each row separately, for example using separate light sources directed at two opposite sides of the arrangement of the master elements. By preference, the rows of master elements are separated by a light-absorbing spacer, wherein the spacer preferably is a part of the first carrier means. The light-absorbing spacer prevents unwanted light from one master element from penetrating into another and thus avoids optical disturbances such as crosstalk. This is particularly advantageous if the master elements in the various rows should be exposed from different angles or using different wavelengths.

The exposure for replicating a master hologram by means of the method according to the invention may be implemented on the basis of various techniques. Hologram replication methods may be divided into relief holograms and volume holograms.

Relief holograms are formed by physical contact between a deformable sensitive layer and a master hologram such that the diffraction pattern of the master hologram is impressed in the sensitive layer.

A volume hologram is written into a sensitive layer, preferably by the interference of two light beams (called a reference beam and an object beam). By preference, a volume hologram is written into the composite web. By preference, this may be implemented by transmission or reflection technology. A sequence of Bragg planes preferably arises as a result of the interference of object and reference beams within the hologram volume. Consequently, a volume hologram preferably has a non-negligible extent in the propagation direction of the light beams, with the Bragg condition applying in the case of the reconstruction at a volume hologram. It is for this reason that volume holograms have a wavelength and/or angle selectivity. The ability of volume holograms to store multiple images at the same time allows production of colored holograms inter alia. Light sources emitting in the three basic colors of blue, green and red may be used for the recording of the holograms. By preference, the three beams simultaneously illuminate a part of the composite web at identical angles. Following the exposure, three holograms are stored in the volume hologram at the same time. The reproduction of the color hologram may exploit the fact that each partial hologram may only be reconstructed by the color with which it was recorded. Consequently, the three reconstructed color sectors are superimposed to form the colored, faithful image, provided that the color components are weighted correctly.

Reflection holograms are reflective holograms which reflect light incident from the light source and consequently act like a mirror. An incidence direction of the reference beam (preferably a light beam incident from the light source) and the object (the master hologram in this case) may preferably be arranged on opposite sides of the composite web. A reference beam passes through the composite web and is subsequently reflected back into the light-sensitive layer of the composite web by the master hologram. Consequently, the reference beam and object beam superimpose in the light-sensitive layer of the composite web in different beam directions in order to create the replicated hologram. By preference, the master hologram may be applied to a surface of the master element or be present in a manner integrated in the substrate body.

The light source for a reflection hologram may be arranged such that the reference beam is incident on the composite web in a desired direction, preferably in a direction desired in the later reconstruction. In a preferred embodiment, the light source is oriented in relation to the master element in such a way that the composite web is situated between the light source and the master element. For example, the light source may be aligned above the master element in such a way that the reference beam is incident downwardly on the composite web in a predetermined direction. By preference, at least some of the reference beam is reflected back into the composite web as an object beam by the master element. Thus, the reference beam and the object beam enter the photopolymer composite from opposite sides and interfere in the light-sensitive layer of the latter in order to replicate the hologram.

Transmission holograms are transmissive holograms, wherein the light from a light source is passed and diffracted by the latter. An incidence direction of the reference beam (preferably a light beam incident from the light source) and the object (the master hologram in this case) may preferably be present in a manner arranged on the same side of the composite web. An incident beam passes through the master hologram and is separated into a (non-diffracted) reference beam and an object beam. Consequently, the reference beam and object beam superimpose in the light-sensitive layer of the composite web with the same beam direction in order to create the replicated hologram.

In a transmission hologram, it may be preferable to arrange the light source in such a way that the composite web may be exposed from the same side by a reference beam and by an object beam. By preference, the light source is oriented in such a way in relation to the master element that a light beam initially passes through the master element and the master hologram before it reaches the composite web. By preference, the light source may be arranged in such a way that light passes through a transparent master element from a side face. By preference, the light source may also be arranged in such a way that light is incident on the composite web through an upper and/or lower surface of the master element. By preference, the incident light beam is refracted in such a way by the master element that a reference beam and an object beam are created, wherein the object beam preferably corresponds to the component of the light diffracted by the master hologram. By preference, the object beam interferes with the non-diffracted reference beam in the composite web in order to replicate the hologram.

In preferred embodiments of the invention, one or more master elements may be used to expose the composite web in order to replicate a transmission hologram therein. By preference, the replicated transmission hologram may be designed such that it is edge lit, and so the holographic image representation may be reconstructed by light from a substantially lateral direction. The replicated transmission hologram may also be configured such that it is illuminated from behind, and so the holographic image representation may be reconstructed by light incident in a manner substantially from the back to the front. It may also be preferable for one or more master elements to be used to expose the composite web and replicate a reflection hologram therein. It might also be desirable for the replicated reflection hologram to be edge lit. For example, such a hologram may be used in a glass pane, at the edges of which light sources are arranged in concealed fashion. The replicated reflection hologram may also be configured such that it is illuminated from the front. Advantageously, such a hologram may create a holographic image representation when illuminated by ambient light and observed relatively orthogonally at eye level. A plurality of such holograms may also be used in a glass pane, for example in the manner as disclosed in WO2020157312A1, in order to create a holographic image representation when observed orthogonally by virtue of light from concealed light sources being reflected along a predetermined path. It may also be advantageous to use one or more master elements to expose the composite web in order to create a hologram that comprises both a reflection hologram and a transmission hologram.

In preferred embodiments of the invention, a reference beam may be directed at a side face of the master elements for the purpose of exposing the holograms. In other preferred embodiments of the invention, it may be preferable that, in addition or in an alternative, a reference beam is directed at an upper and/or lower horizontal face of the master elements.

Various techniques for exposing the composite web with the master elements using different reference beam angles and for creating different types of holograms are explained in the detailed description on the basis of the drawings. Reference is made to the fact that these techniques may optionally be combined with one another and with various structural arrangements of the apparatus. An important advantage of the present invention consists in the fact that, by preference, a plurality of types of exposure may be performed in the same apparatus and during the same iteration.

By preference, the method is implemented with the aid of an apparatus for replicating a plurality of holograms, comprising
a first carrier means for arranging a sequence of master elements from a multiplicity of master elements on the basis of a plurality of holograms to be replicated, in such a way that upper faces of the master elements are aligned in a horizontal plane,
a lamination module for detachably laminating a light-sensitive composite web on the aligned upper faces of the master elements, and
an exposure module for exposing the master elements in order to replicate the master holograms in the light-sensitive composite web, and
a detachment module for detaching the exposed composite web from the master elements,
   wherein the master elements are detachably incorporated in the first carrier means such that a sequence and/or composition of the master elements for the replication of the plurality of holograms is variable, and wherein the master elements are further incorporated in the first carrier means such that two or more faces of the master elements are optically accessible for exposure purposes.

The person of average skill in the art recognizes that technical features, definitions and advantages of preferred embodiments of the method according to the invention also apply to the apparatus used to this end, and vice versa.

Within the meaning of the invention, a “module” preferably refers to a workstation in a continuous manufacturing method, preferably equipped with the required technical means for performing the method step. Different modules may, but need not, be separated from one another by a housing or dividing wall. It may be preferable within the meaning of the invention for the lamination module, the exposure module and the detachment module to be situated in the same housing.

The use of the apparatus is advantageous in that a plurality of master holograms may be exposed in a single series and great flexibility in the exposure method is provided at the same time. By providing a multiplicity of master elements and the linear arrangement thereof, it is possible to reduce the size and the weight of each master element.

The complexity of a system may be reduced by using a plurality of relatively small master elements to cover an area that is normally covered by a single large master element. Minor changes or defects for one master element do not necessitate the exchange of all master elements. This significantly reduces the costs. For example, the transparent substrates that are used to accommodate the master holograms may thus be prepared and polished more easily. The transport and storage of smaller and lighter master elements is also more economical as these may be stacked in space-saving fashion, transported without specific lifting apparatuses and easily inserted into or taken from the apparatus.

The lamination module preferably brings the light-sensitive material into mechanical contact with the master elements and ensures sufficient optical contact with the master holograms. Particularly homogenous contact between master element and light-sensitive material, which effectively avoids bubbles or folds, may be established as a result of laminating rather than simply placing the light-sensitive material on the master elements. As a result of using a composite web made of the light-sensitive material, this may be efficiently implemented repeatedly over the arrangement of the master elements, and so the composite web moves while the arrangement of the master elements preferably remains stationary. A detachable lamination in particular allows the composite web to be removed without damage or residues and allows it to run on over further stations in a production line. By preference, the exposure module directs light at the composite web and/or master elements in order to replicate a master hologram contained in the master element in the composite web.

The detachment module preferably ensures a residue-free detachment of the composite web from the master elements with sufficient force, without damaging the web.

Integrating the lamination module, exposure module and detachment module in the same apparatus allows the apparatus to be designed very compactly; this is suitable, in particular, for small series and customer-specific end products.

The lamination module preferably comprises a lamination roller. The latter may be housed in the apparatus in height-adjustable fashion and roll along a predetermined trajectory in order to press the composite web onto the top side of the master elements. It may be advantageous for the lamination roller to be housed such that it is able to move along a predetermined path, wherein the lamination module preferably comprises an actuator for moving the lamination roller along this path. By preference, the path comprises diagonal lowering of the lamination roller from a first height and a first lateral position, which is not located directly over the first carrier means, in the direction of an upper face of a first master element. The path preferably also comprises a horizontal rolling movement of the lamination roller at a second height, lower than the first, along the top side of the master elements until said roller reaches a last master element n in the sequence. The lamination roller is preferably configured such that it is kept at the second height and in a second lateral position downstream of the last master element during an exposure process for the sequence.

In a preferred embodiment of the invention, the lamination module comprises means for adjusting the height of the lamination roller. By preference, the means for adjusting the height of the lamination roller are configured to bring the lamination roller from a storage position to a lamination position on the top side of the master elements. This height adjustment preferably comprises a translation of the lamination roller over a stretch of at least 1 cm, preferably at least 5 cm and more preferably at least 10 cm. A person skilled in the art is aware of suitable means for such a height adjustment. Before or after the lamination, the lamination roller can consequently be brought outside of a region between the master elements and/or input coupling elements and/or light source. This allows for greater degrees of freedom during the application of the input coupling elements and/or the exposure of the master elements.

In a further preferred embodiment of the invention, the means for adjusting the height of the lamination module are also configured to adjust the height of the lamination roller. By preference, the means for adjusting the height of the lamination roller are configured to adjust the height of the lamination roller by up to +/−50 μm, preferably +/−100 μm and particularly preferably +/−500 μm. The height is preferably adjusted with a resolution of at least 50 μm, in particular at least 10 μm. The resolution of the height adjustment preferably relates to the smallest step by which the lamination roller is able to be translated for height adjustment purposes.

Such a height adjustment may advantageously compensate for very small variations in the position of the surface or in the surface quality of the master elements. For example, the master elements may only position the first carrier means itself within tolerances. On account of manufacturing tolerances, the actual height of a master element may also depend on a target height. Thus, these tolerances may be compensated for when positioning the lamination roller such that the latter is always applied to the surface of the master elements with a predetermined pressure. A slightly tilted position of the first carrier means may also be compensated for in this manner should the first carrier means not have a tiltable design, as explained above, in any case. These measures improve the optical contact between the composite web and the master elements and avoid excessive lamination pressure at the same time.

In a further preferred embodiment of the invention, the lamination roller is initially brought to a predetermined position on the surface of the master elements and then adjusted in height by smaller movement steps. In this way, the lamination roller can be brought to the actual surface of the master elements particularly precisely.

By preference, the height adjustment of the lamination roller is pressure regulated. One or more sensors, in particular a compression force sensor, may be used to this end. By preference, a compression force sensor is used to determine that a lamination roller is in contact with the surface of the master elements with a pressure in a predetermined range. For example, the pressure sensor may be a film on the surface of the lamination roller.

The lamination roller is cushioned in a further preferred embodiment of the invention, the cushioning preferably being configured for a height tolerance of at least +/−50 μm, preferably +/−100 μm and particularly preferably +/−500 μm. Such cushioning may compensate for tolerances in the surface quality and/or in the relative positioning of the master elements and the lamination roller. The cushioning may also eliminate air gaps and/or bubbles between the master elements and the lamination roller and thus improve the optical contact between the composite web and the master elements.

The cushioning of the lamination roller is preferably implemented mechanically, (electro) magnetically, hydraulically or pneumatically, with a pneumatic cushioning being particularly preferred. By preference, the cushioning of the lamination roller is pressure regulated, in particular in order to establish and maintain a preferred pressure between the lamination roller and the master elements.

In a further preferred embodiment of the invention, the first carrier means and/or the second carrier means comprises one or more sensors for determining contact with a further process component. By preference, a compression force sensor is used to determine that the first carrier means is in contact with a lamination roller and/or with the second carrier means with sufficient pressure.

In a preferred embodiment of the invention, the exposure module comprises a light source.

In a preferred embodiment, the light source emits a coherent light beam. Coherence preferably refers to the property of optical waves whereby there is a fixed phase relationship between two wave trains. As a result of the fixed phase relationship between the two wave trains, spatially stable interference patterns may arise. With regard to coherence, a distinction can be made between temporal and spatial coherence. Spatial coherence preferably represents a measure for a fixed phase relationship between wave trains perpendicular to the propagation direction and is given, for example, for parallel light beams. Temporal coherence preferably represents a fixed phase relationship between wave trains along the propagation direction and is given in particular for narrowband, preferably monochromatic light beams.

The coherence length preferably denotes a maximum path length difference or time-of-flight difference that two light beams from a starting point have, so that a (spatially and temporally) stable interference pattern arises during their superposition. The coherence time preferably refers to the time that the light needs to travel a coherence length.

In preferred embodiments, the light source comprises a laser. Particularly preferably, this is a narrowband, preferably monochromatic laser with a preferred wavelength in the visible range (preferably 400 nm to 780 nm). Non-limiting examples include solid-state lasers, preferably semiconductor lasers or laser diodes, gas lasers or dye lasers.

Other light sources, preferably coherent light sources, may also be used. Preference is given to narrowband light sources, preferably monochromatic light sources, including, for example, light-emitting diodes (LEDs), optionally in combination with monochromators.

For replication at different wavelengths, it may be preferable to provide illumination radiation in different wavelength ranges, e.g. in a red wavelength range (preferably 630 nm-700 nm), a green wavelength range (preferably 500 nm-560 nm) and/or a blue wavelength range (preferably 450 nm-475 nm).

For example, a laser system with three monochromatic lasers or a polychromatic laser with a laser emission in each the red, green or blue (RGB) range may be provided for this purpose. It may also be preferable for the light source to comprise a white-light laser and an adjustable wavelength filter, the latter being configured such that the wavelength used to expose the composite web can be set.

The exposure module may also comprise one or more motors that are configured such that they set an angle of the light source and/or move the light source along a trajectory. For example, the light source may be configured as a scanning light source. The light source may also be equipped with a shaft, along which it is able to slide. The exposure module may also comprise one or more mirrors, the position of which may likewise be adjustable, in order to steer the path of a light beam onto the master elements and/or the composite web. The exposure module may also contain one or more lenses, for example a diverging lens, in order to broaden a light beam on the master element. It may also be advantageous for the exposure module to be equipped with means for setting the intensity of the light from the light source incident on the master elements and/or the composite web.

In a preferred embodiment of the invention, the detachment module comprises a detachment roller which is positioned below a height position of a composite web. By preference, the detachment module comprises an actuator for moving the detachment roller along a path following the exposure. By preference, this path comprises a raising of the detachment module such that a composite web located thereabove is also raised.

In a further preferred embodiment of the invention, the first carrier means is configured to carry at least two, preferably at least three and more preferably at least four master elements.

In a further preferred embodiment of the invention, the apparatus comprises a transport module for transporting a light-sensitive composite web over the sequence of master elements. By preference, the transport module comprises one or more transport rollers, for example a drawing roller which moves the composite web forward. This may lead to a semi-continuous process with a roll-shaped intermediate product which can be transported to further workstations for cutting processes.

In a preferred embodiment of the invention, the apparatus also comprises an affixation module. This ensures an even more compact apparatus and increases the quality of the end product since affixation can be implemented immediately, before optical or mechanical disturbances impair the just-exposed composite web.

The apparatus comprises a control unit in a further preferred embodiment of the invention. The control unit preferably comprises a processor and a memory and is preferably configured to control a selection and, optionally, the arrangement of the sequence of master elements, wherein the processor reads sequence data from the memory and signals to an actuator and/or a user the sequence in which the master elements should be arranged.

Thus, the control unit can preferably ensure that the master holograms are arranged in the first carrier means according to a predetermined order, for example an order in which relatively large components that integrate the replicated holograms therein are processed on a parallel manufacturing line.

By preference, the method according to the invention is implemented with the aid of a system for replicating a plurality of holograms, comprising an apparatus as described above and a multiplicity of master elements. The master elements comprise a substrate body and at least one master hologram, wherein a sequence of master elements can be selected from the multiplicity of master elements on the basis of the plurality of holograms to be replicated.

### DETAILED DESCRIPTION

The invention will be explained in more detail below by means of examples and figures, without being limited thereto.

### BRIEF DESCRIPTION OF THE FIGURES

FIG. 1 is a schematic illustration of an apparatus for performing the method according to the invention.

FIG. 2 is a schematic illustration of a further preferred embodiment of the apparatus, in which input coupling elements are used.

FIG. 3 is a schematic illustration of a preferred embodiment of the apparatus, in which light-absorbing spacers separate the master elements and input coupling elements.

FIG. 4 is a schematic plan view which illustrates an exchange of master elements in a first carrier means.

FIG. 5 is a schematic plan view of an arrangement of master elements in two rows in a first carrier means.

FIG. 6 is a schematic side view of a preferred embodiment of the apparatus in different stages: A) before a lamination, B) during a lamination, C) during an exposure, D) following the exposure, E) during a detachment, and F) following a detachment.

FIG. 7 is a schematic front view of a reconstruction of an edge-lit reflection hologram.

FIG. 8 is a schematic front view of a reconstruction of an edge-lit transmission hologram.

FIG. 9 is a schematic front view of an exposure process for replicating an edge-lit reflection hologram with the aid of an input coupling element.

FIG. 10 is a schematic front view of an exposure process for replicating an edge-lit transmission hologram with the aid of an input coupling element.

FIG. 11 is a schematic front view of an exposure process for replicating a reflection hologram that was exposed from above.

FIG. 12 is a schematic front view of an exposure process in which a multiplex hologram is replicated, the latter comprising both a reflection hologram and an edge-lit transmission hologram.

FIG. 13 is a schematic front view of an exposure process in which a transmission hologram is exposed from below.

FIG. 14 is a schematic front view of an exposure process for replicating a multiplex hologram comprising a transmission hologram and an edge-lit reflection hologram.

FIG. 15 is a schematic front view of an exposure process in which edge-lit transmission holograms are exposed simultaneously from both sides of a first carrier means with two rows.

FIGS. 16A-16F show the use of a wedge-shaped input coupling element with an optical fluid by way of example.

FIGS. 17A-17F show the use of a cylindrical input coupling element with an optical fluid by way of example.

### DETAILED DESCRIPTION OF THE FIGURES

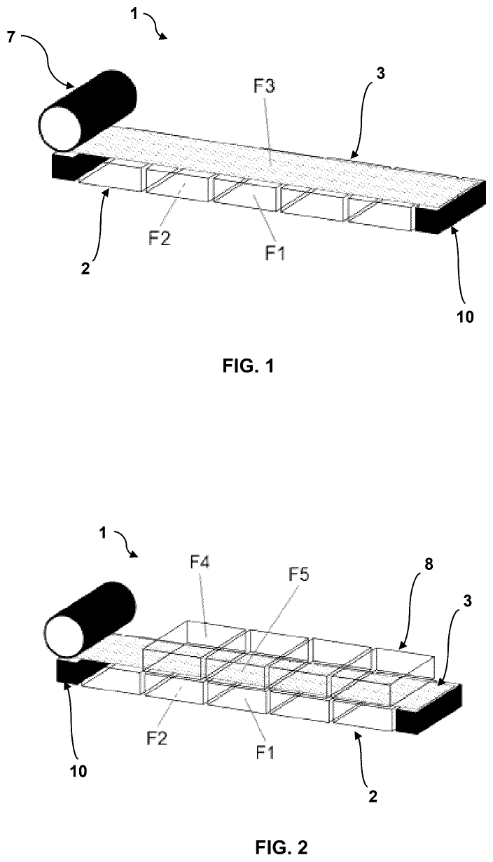

FIG. 1 shows a schematic illustration of an apparatus 1 for performing the method according to the invention. For reasons of simplicity, the exposure and the detachment module are not shown. The figure schematically shows a first carrier means 10 which holds a linear arrangement of five master elements 2 such that the horizontal top sides of these elements are flush with one another and with the first carrier means 10. A simple embodiment of the first carrier means 10 is shown; it comprises only two end blocks which may preferably be affixed in their position, for example by way of secure clamping to one another or to a stationary surface. However, any desired embodiment of the first carrier means 10 may be used, e.g. a frame that is connected along the underside of the master elements or an arrangement of cavities separated by bars and serving to accommodate the master elements 2 such that at least two of their surfaces are optically accessible.

By preference, the first carrier means 10 may for example comprise a frame element along a lower outer edge of the master elements 2, said frame element covering no more than 50%, and preferably up to a maximum of 40%, 30%, 20% or 10% or less, of the side faces of the master elements 2. Within the meaning of the invention, such side faces are preferably considered to be optically accessible faces. In FIG. 1, the master elements 2 have at least three optically accessible faces. F1 and F2 are optically accessible side faces. F3 is an upper face and only covered by the composite web 3. However, the composite web 3 is not a light-absorbing material, and so the upper face F3 may be considered to be optically accessible. The master hologram 6 in the master elements 2 may be exposed by directing light to one or more of these optically accessible faces. An unwritten underside of the master elements 2 may likewise be optically accessible, especially if a first carrier means 10 with an appropriate frame structure is chosen. The bandwidth of the angles from which the exposure may be implemented is consequently very large and suitable for very different exposure arrangements.

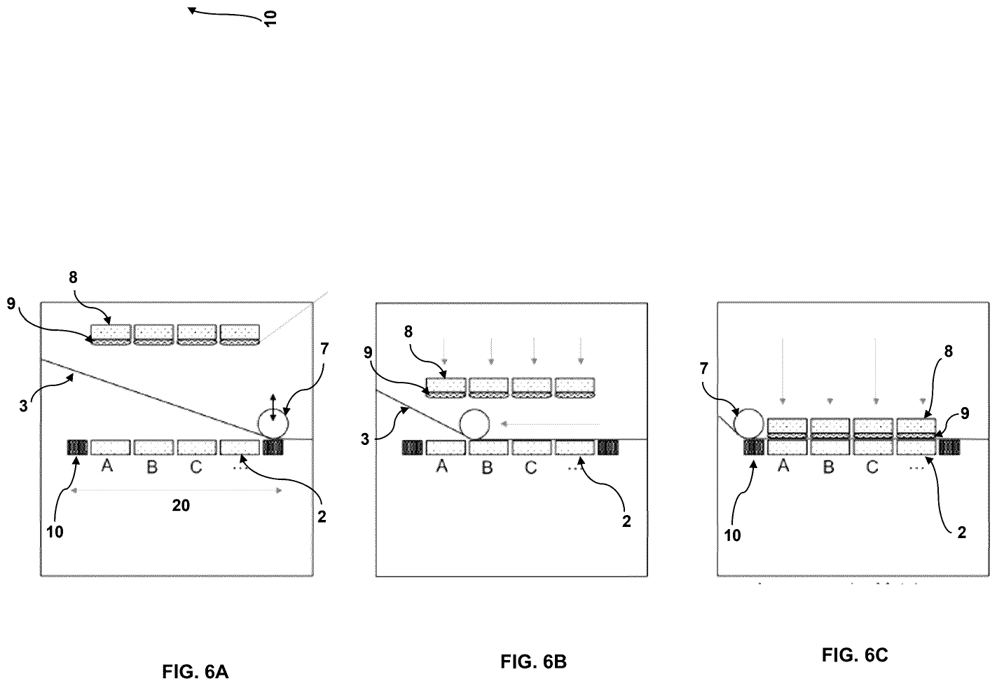

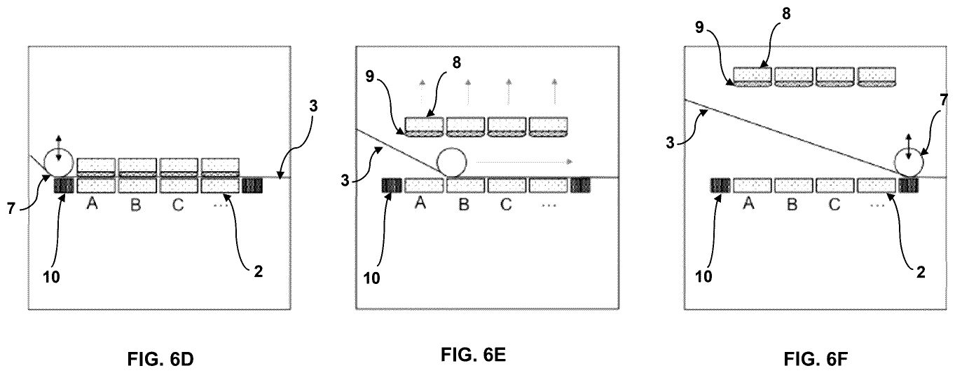

The composite web 3 is stretched over the top side of the master elements 2 and of the first carrier means 10. This arrangement arises from laminating the composite web 3 on the flush surface with the aid of the lamination module. In this case, the lamination module comprises the lamination roller 7. For example, the latter may be lowered onto the composite web 3 from the right-hand side in the figure, may press on the flush surface and may roll in a relative movement to the position shown to the left in FIG. 1 (cf. also FIGS. 6A-F). To avoid optical disturbances during the exposure, the first carrier means 10 and the lamination roller 7 either preferably comprise a light-absorbing material or are preferably coated with an absorber layer 5.

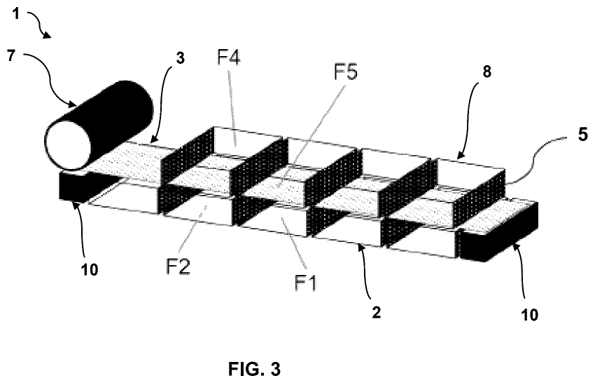

FIG. 2 shows a schematic illustration of a further embodiment of the apparatus 1. The structure of the embodiment is analogous to the embodiment illustrated in FIG. 1, the main difference being that the input coupling elements 8 are present in a linear arrangement above the master elements 2.

Even though the input coupling elements 8 may be placed manually on the master elements 2, it is preferable that they are carried by a second carrier means (not shown here) such as for example a frame. This allows for a precise and repeatable placement of the input coupling elements 8. In the embodiment shown, all input coupling elements 8 have the same size and the same shape, just like all master elements 2. The size and shape of the input coupling elements 8 is also identical to that of the master elements 2. Each input coupling element 8 corresponds to a single master element 2 and is placed directly over the latter such that the side faces of an input coupling element 8 are flush with the side faces of the corresponding master element 2.

It is also preferable that at least two surfaces of each input coupling element 8 are optically accessible. In this embodiment, the input coupling element 8 is optically accessible from at least its side faces F4 and F5 and an upper face (without a reference sign). The input coupling elements 8 comprise a transparent block made of preferably an identical material to that of the substrate body 14 of the master elements 2.

FIG. 3 shows a further preferred embodiment of the apparatus 1. The structure of the apparatus 1 is analogous to that from FIG. 2. The main difference consists in the use of light-absorbing spacers 4 between the master elements 2. In the figure, these are shown in black. Even though their top side is not visible, the top side is flush with that of the first carrier means 10 and of the master elements 2. FIG. 3 also shows a row of light-absorbing spacers 4 which separate the input coupling elements 8 from one another such that a lower face of the spacer 4 is flush with a lower face of the input coupling elements 8. It is preferable for the spacers 4 to be arranged between the inner side faces of the master elements 2 and of the input coupling elements 8 and in contact therewith. This preferably means that the spacers 4 are arranged along the face which separates one master element 2 from an adjacent master element 2.

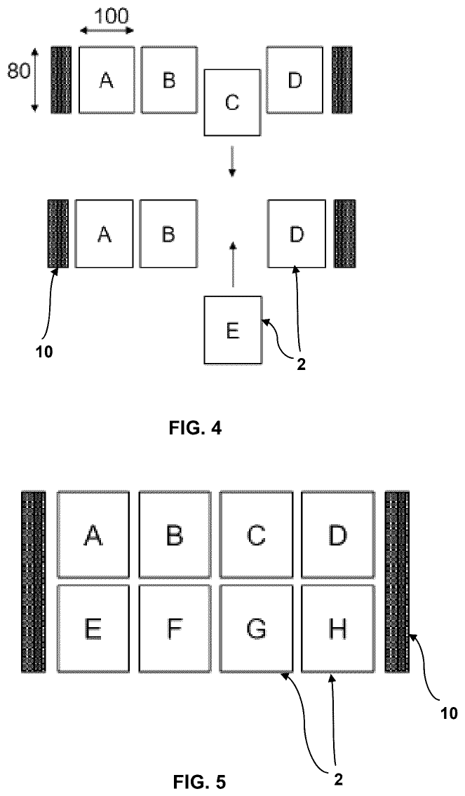

FIG. 4 is a schematic plan view of a one-row first carrier means 10, which comprises four master elements A-D. The figure illustrates the easy way in which the master elements 2 can be exchanged on the basis of the type case principle according to the invention. In this case, e.g. the master element C can be removed by virtue of being e.g. horizontally displaced. The master element E may be inserted into the gap in the same manner, for example by virtue of being pushed into the corresponding recess. The figure also shows the dimensions of the master elements 2 in exemplary fashion. The width of a master element 2 may be e.g. approx. 80 mm, while the length may be e.g. approx. 100 mm.

FIG. 5 is a schematic plan view of a two-row first carrier means 10, which comprises eight master elements A-H. By virtue of being able to provide a greater number of master elements 2 of the same size as in FIG. 4, the process may be accelerated since more holograms are able to be produced in each iteration. The size of the first carrier means 10 is adapted in order to house a greater number of master elements 2 in two rows.

FIG. 6 is a schematic side view of a further embodiment of an apparatus for performing different method steps during a replication of the holograms.

FIG. 6A shows the positions of the various elements of the apparatus just before the start of a lamination step. Before the lamination starts, the master elements A, B, C, etc. are placed in a linear arrangement in the first carrier means 10. In this case, the carrier means 10 comprises only a single row. The number of master elements 2 arranged in the single row and their length determine the repetition length or “repeat length” 20.

The arrows on the lamination roller 7 in FIG. 6A indicate that the lamination roller 7 is moving vertically (upward/downward). To enable a travel of the composite web 3 between the iterations, the lamination roller 7 is advantageously situated in a first position above the first carrier means 10 and above the composite web 3 such that the movement of the composite web is not impaired by friction between the lamination roller 7 and the composite web 3. It is also preferable for the lamination roller 7 to be positioned to the side during the travel of the composite web 3, in such a way that said lamination roller is situated outside of the space between the input coupling elements 8 and the master elements 2. This enables a free vertical movement of the input coupling elements 8 in the space between them and the master elements.

At the start of the lamination procedure, the lamination roller 7 is lowered to a second height such that it reaches the plane of the aligned horizontal surfaces of the master elements 2.

As also shown in FIG. 6A, the input coupling elements 8 of this embodiment comprise a lower input coupling section 9. The input coupling section 9—in contrast to the rigid main body of the input coupling element 8—consists of an elastic, transparent material such as e.g. silicone.

FIG. 6B shows the positions of the various elements of the apparatus 1 during the lamination process. The lamination roller 7, which traps the composite web 3 between it and the first carrier means 10 and/or the master elements 2, rolls horizontally in an upstream direction (to the left in the figure). This may lead to an upstream roll of the composite web 3 being passively unwound. The lamination brings the composite web 3 into optical contact with the top sides of the master elements 2. The input coupling elements 8, which are housed on a second carrier means (not shown), may be lowered during the horizontal movement of the lamination roller 7. By preference, the speed of lowering the input coupling elements 8 and/or the speed of rolling the lamination roller 7 are matched to one another in order to ensure a fast application of the input coupling elements 8 without the risk of mutual impediment.

FIG. 6C shows the positions of various elements of the apparatus during the exposure. The input coupling elements 8 are lowered to such an extent that the input coupling sections 9 come into contact with the composite web 3 and are elastically pressed against the top side of the master elements 2. In this way, the input coupling sections 9 ensure a particularly homogeneous and gap-free optical contact between the master elements 2, the composite web 3 and the input coupling elements 8. The exposure module is not depicted in this figure but may be designed in different ways, including one or more light sources, mirrors, lenses, color filters, axes and/or motors.

FIG. 6D shows the positions of various elements of the preferred apparatus following the exposure procedure. The input coupling elements 8 are beginning to be raised back to their first height. At the same time, the lamination roller 7 starts to roll horizontally downstream. FIG. 10 shows the input coupling elements 8 and the lamination roller 7 in intermediate positions while they are moved following the exposure.

FIG. 6E shows the apparatus 1 during a detachment step in which the composite web 3 is detached from the top side of the master elements 2. To this end, the lamination roller 7 is moved horizontally to the right. By preference, a detachment roller situated in front of the master elements 2 (not depicted here) may be raised upwardly. The composite web 3 is arranged above the detachment roller and so the composite web is also raised by the detachment roller being raised.

FIG. 6F shows the apparatus 1 following the detachment step. The input coupling elements 8 were raised to their first height in full, and the composite web 3 was detached from the master elements 2. A sufficient distance remains between the raised composite web 3 and the master elements 2 such that the latter may be removed, replaced or rearranged without coming into contact with the composite web 3. Moreover, the lamination roller 7 may be raised back to its first height during this stage. As a result, the composite web 3 is no longer clamped between the lamination roller 7 and the first carrier means 10. In this stage, the composite web 3 may travel onward to subsequent workstations used in the method, for example to an affixation module. The travel of the composite web 3 is preferably brought about by a transport roller (not depicted here).

The following figures illustrate various exemplary exposure techniques and hologram types which may be produced using the method according to the invention and with the aid of the apparatus 1.

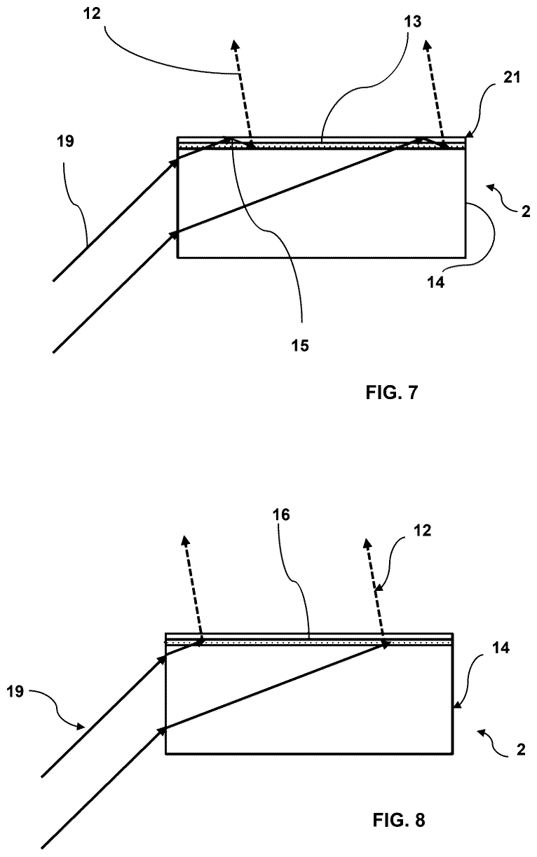

FIG. 7 is a schematic front view of an edge-lit reflection hologram 13. The edge-lit reflection hologram 13 is situated on a substrate body 14 and trapped under a cover 21. The reflection hologram 13, the substrate body 14 and the cover 21 form a master element 2. The arrows represent light beams for reconstructing a holographic image from the reflection hologram 13. During the reconstruction, a reconstruction beam 19 is directed obliquely upward at a side face of the master element, in such a way that the beam is reflected to the reflection hologram 13 at a suitable angle. The beam 19 is refracted by the transparent substrate body 14 of the master element 2. The refracted beam passes through the reflection hologram 13 situated in the master element 2 and is reflected back to the reflection hologram 13 off an upper interface of the cover 21. Reference numeral 15 schematically indicates the total-internal reflection caused by the interface. The angle at which these beams that were subjected to total-internal reflection are incident on the reflection hologram 13 is decisive for the reconstruction of the latter. The beams that were subjected to total-internal reflection are reflected by the reflection hologram 13, as depicted by means of the dashed arrows. The created holographic image thus is substantially orthogonal to the surface of the hologram 13, facilitating readability if the latter is for example placed in a perpendicular face. The illumination is referred to as edge lit since the reconstruction beam is incident on the hologram or the substrate body 14 substantially from the side.

Such a hologram can advantageously be used in glass panes that are illuminated from a side edge such that the light source remains compact and concealed. The holographic image is essentially only visible if the light source such as an LED is activated from a suitable angle, for example in order to display a warning symbol on a windscreen.

The edge-lit reflection hologram 13 may act as master hologram. The master hologram and the light-sensitive composite web must be exposed from an appropriate angle during the replication so that the replicated holograms are also able to create holographic images that are visible from the desired angle. This can be implemented with the aid of embodiments of the apparatus and of the method according to the invention, as explained hereinafter.

FIG. 8 is a schematic front view of a reconstruction of an edge-lit transmission hologram 16. The edge-lit transmission hologram 16 is also situated on a substrate body 14 and trapped under a cover 21. The transmission hologram 16, the substrate body 14 and the cover 21 form a master element 2. During the reconstruction, a reconstruction beam 19 is directed obliquely upward at a side face of the master element 2, in such a way that the beam is incident on the transmission hologram 16 at a suitable angle. The beam 19 is refracted by the transparent substrate body 14 of the master element 2 and incident on the transmission hologram 16 at this angle. When passing through the transmission hologram 16, the reconstruction beam 19 is at least partly diffracted by the edge-lit transmission hologram 16 in order to create a holographic image.

In this example, the beams 12 for forming the holographic image are also substantially orthogonal to the surface of the hologram. This may facilitate the observation, depending on the position of the hologram relative to the eye level of the user. This edge-lit transmission hologram 16 may also be used as master hologram 6, in order to replicate the edge-lit transmission hologram 16 in a light-sensitive composite web 3. In order to ensure the desired reconstruction angle, the master hologram 6 and the composite web 3 must be exposed at precisely the same angle at which the reconstruction beam 19 is incident on the edge-lit transmission hologram 16 in FIG. 8.

Especially in the event of edge-lit holograms, as depicted in the examples of FIG. 7 and FIG. 8, the required angle at which a reconstruction light must be incident on the replicated hologram in order to be reflected and/or diffracted correctly may be acute. The direct exposure at such an acute angle may lead to mechanical challenges. The use of the substrate body 14 increases the flexibility with which the light source can be positioned and moved for the exposure. This is because the angle of incidence of the light on the master hologram 6 depends not only on the position of the light source but also on the refraction caused by the substrate body 14.

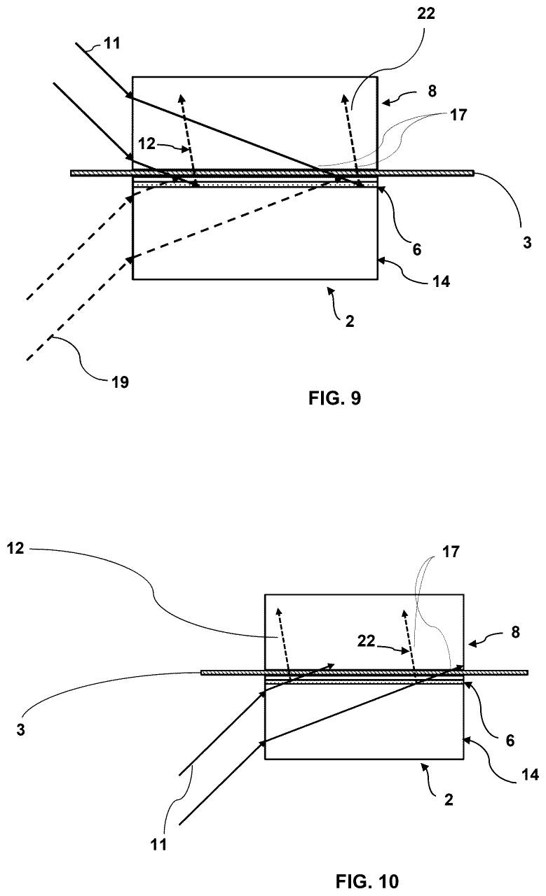

FIG. 9 is a schematic front view of an exposure process for replicating an edge-lit reflection hologram 13 with the aid of an input coupling element 8. A reference beam 11 is directed obliquely downward at a side face of the input coupling element 8, which is depicted as a block above the master element 2. The reference beam 11 is refracted by the input coupling element 8, and the refracted reference beam 11 reaches the master hologram 6 through the composite web 3. The refraction caused by the input coupling element 8 contributes to attaining the acute angle of incidence required for the edge-lit hologram. The master hologram 6 reflects the reference beam 11 such that an object beam 22 passes through the composite web 3 from the master hologram 6 (in the same direction as the reconstructed beam 12 from FIG. 7). The object beam 22 interferes with the reference beam 11 in the light-sensitive material of the composite web 3 in order to create the reflection hologram. These two beams are incident on the light-sensitive material from different sides, and so the replicated hologram is a reflection hologram. Reference sign 17 schematically indicates the two interfering beams.

A reconstruction beam 19 can be used to show the reflection hologram. The reconstruction beam 19 is reflected off the microstructure of the exposed light-sensitive material in the direction of the dashed line with reference sign 12, as explained in detail for FIG. 7.

FIG. 10 is a schematic front view of an exposure process for replicating an edge-lit transmission hologram 16 with the aid of an input coupling element 8. A reference beam 11 is incident upwardly in an oblique direction on a side face of a master element. The reference beam 11 is refracted by the substrate body 14 of the master element 2, and the refracted beam is transmitted through the master hologram 6 and through the composite web 3. Some of the reference beam 11 is transmitted without diffraction through the master hologram 6 and some is diffracted in order to create an object beam 22 that also passes through the composite web 3. On account of the optical contact between the input coupling element 8, the composite web 3 and the master element 2, there is essentially no interface at which there is a substantive change in the refractive index between these elements. Hence unwanted reflections at the interfaces which might disrupt the exposure are avoided. This optical contact is also achieved by laminating the composite web 3 on the master element 2, by the optional use of optical fluids and by the suitable selection of materials with similar refractive indices.

The diffracted object beam 22 and the non-diffracted transmitted reference beam 11 interfere in the light-sensitive material of the composite web 3 in order to write the transmission hologram. The two interfering beams are labeled by reference sign 17. Consequently, the two beams are incident on the light-sensitive material from the same side or in the same beam direction in order to replicate a transmission hologram in the composite web 3. A reconstruction beam incident on the composite web from the same angle as the refracted reference beam 11 can be used to reconstruct the hologram. The reconstructed beam is schematically labeled by the dashed arrows 12.

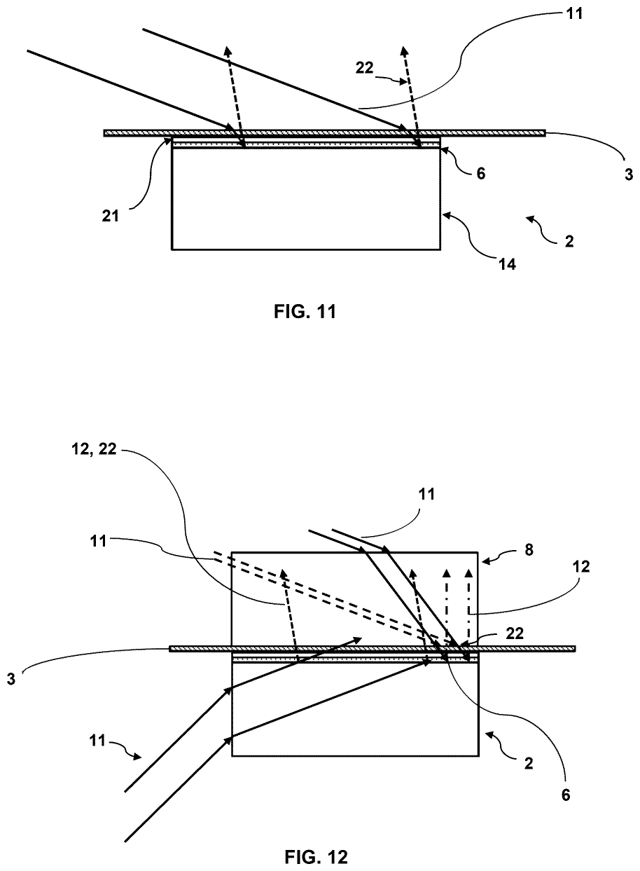

FIG. 11 is a schematic front view of an exposure process for replicating a reflection hologram. No input coupling element 8 is used in this embodiment. The top side of the master element 2 is optically accessible during the exposure. A reference beam 11 is incident in obliquely downward fashion on the composite web 3 and refracted by the composite web 3 and/or cover 21 such that said reference beam is transmitted to the master hologram 6 at a suitable angle. The master hologram 6 reflects the reference beam 11 to form an object beam 22 which passes the composite web upwardly in the direction of the dashed arrow. Since the object beam 22 and the reference beam 11 are incident on the light-sensitive material of the composite web 3 from different sides or in different beam directions, the replicated hologram is a reflection hologram.

FIG. 12 is a schematic front view of an exposure process in which a multiplex hologram is replicated. The master hologram 6 comprises both a reflection hologram and an edge-lit transmission hologram, both of which may be replicated in the composite web. The transmission hologram is created in a manner similar to what was explained above for FIG. 10. To create the reflection hologram, a further reference beam 11 is directed at an angle at an upper face of the input coupling element 8. Said beam is refracted by the input coupling element 8 and transmitted to the master hologram 6 through the composite web 3. The master hologram 6 reflects the reference beam 11 in order to create an object beam 22 that is transmitted upwardly through the composite web 3.

The dotted-dashed arrows 22 show the reflected object beams of the reflection hologram which interfere with the reference beam 11 in order to create a reflection hologram in the light-sensitive material of the composite web 3. By contrast, the upward dashed arrows 22 show the diffracted object beams of the transmission hologram, which interfere with the non-diffracted component of the reference beam 11 incident from obliquely below in order to create an edge-lit transmission hologram 16 in the composite web 3.

In this arrangement, it may be advantageous to expose the transmission hologram and the reflection hologram separately. The input coupling element 8 can be brought into contact with the composite web 3 during the exposure of the transmission hologram 16, whereas it is removed during the exposure of the reference hologram. In such a case, the reference beam 11, which is used to write to the reflection hologram, is not diffracted by the input coupling element 8, as indicated by the dashed arrows 11. This may be taken into account when setting the angle of the light source such that the desired reconstruction signal of the hologram can be created.

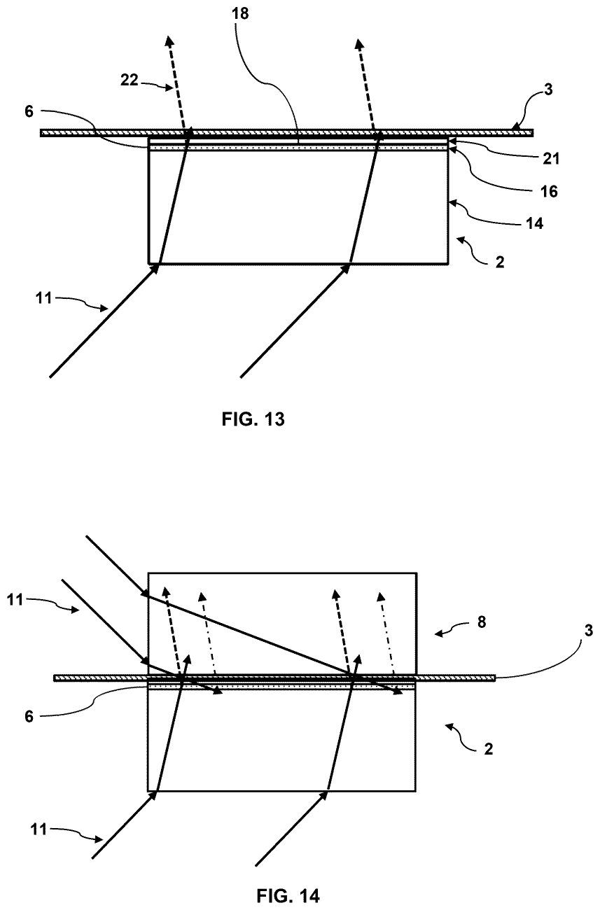

FIG. 13 is a schematic front view of an exposure process in which a transmission hologram 16 is exposed from below. In this example, one of the at least two optically accessible faces of the master element is the lower face. The height of the master element 2 or of the substrate body 14 may be advantageously utilized to refract the light of a reference beam 11 and ensure the desired angle of incidence of the light. Input coupling through a polished underside can be implemented as a result.

FIG. 14 is a schematic front view of an exposure process for replicating a multiplex hologram comprising a transmission hologram 18 and an edge-lit reflection hologram 13. The transmission hologram 16 is replicated in a manner similar to what was explained above for FIG. 13. The light source is aligned in such a way below the master element 2 that a reference beam 11 is directed obliquely upward. The reflection hologram 13 is replicated by an edge-lit method with the aid of an input coupling element 8, as explained above for FIG. 9. In this embodiment, the angles of the reference beams 11 that are used to create the transmission hologram and the reflection hologram are selected in such a way that the optical signal which is created by the reconstruction of both holograms extends in the same direction, as depicted by the two types of dashed arrows.

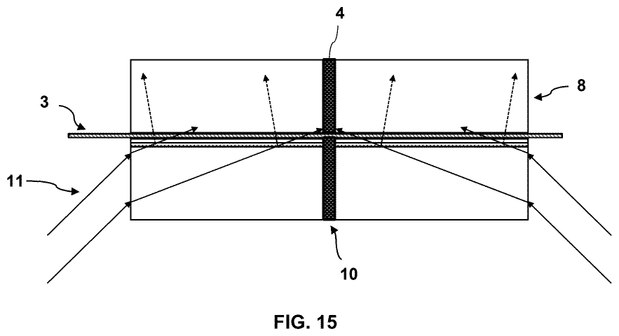

FIG. 15 is a schematic front view of an exposure process in which two edge-lit transmission holograms 16 are exposed simultaneously from both sides of a first carrier means 10 with two rows. In this example, the first carrier means 10 is configured such that it comprises two rows of master elements 2. The two rows are separated by a light-absorbing spacer 4. Moreover, the input coupling elements 8 in the second carrier means are separated by an analogous light-absorbing spacer 4. The spacers 4 cause a buffer in the composite web 3 to be kept free from exposure. Moreover, the composite web 3 can be simultaneously exposed from two directions, as shown in the figure. This increases the speed of the method. In this exemplary embodiment, the exposure method replicates a transmission hologram 16 on the two shown master elements 2 in a composite web 3. Nevertheless, it is possible for each master hologram 6 to be exposed from a different angle and/or a different type of hologram to be created. As a result of the light-absorbing spacer 4, the reference beam 11 that is used to expose one master hologram 2 does not penetrate into the adjacent hologram. This prevents disturbances such as “crosstalk”, and the quality of the holograms produced is increased.

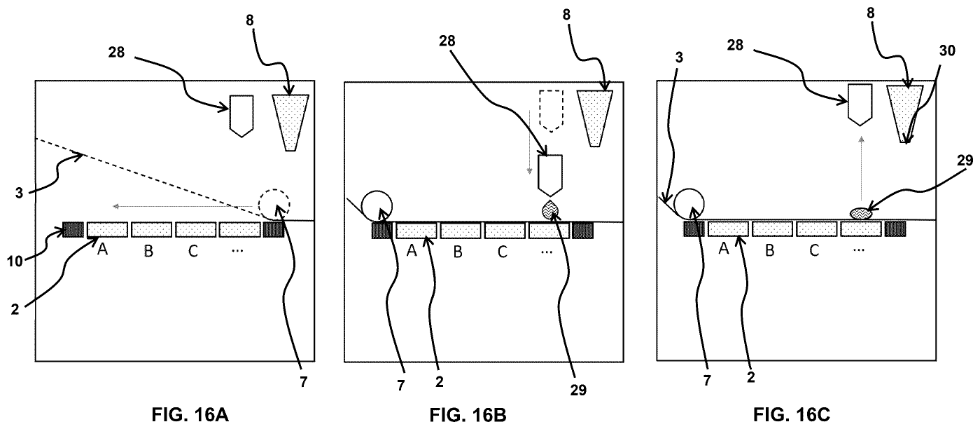

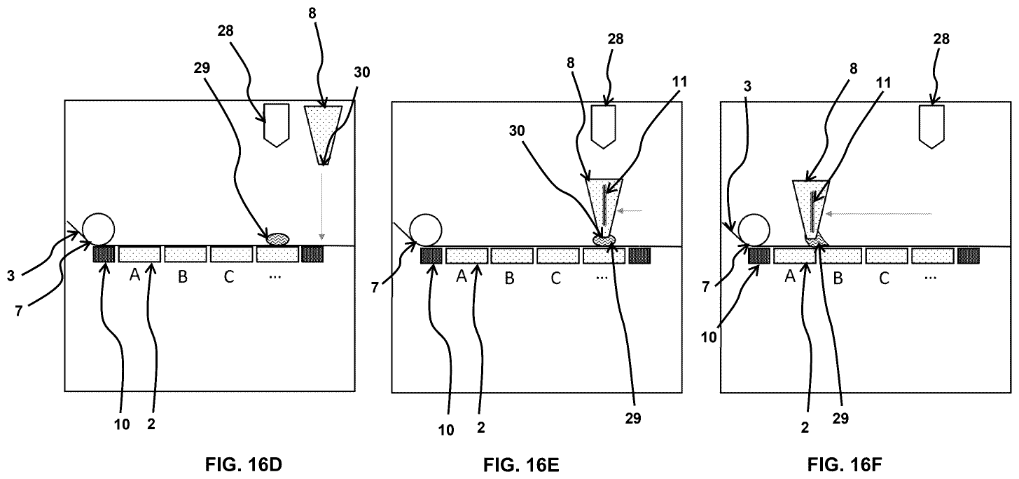

FIGS. 16A-16F schematically show an embodiment of the invention, wherein the input coupling element 8 is pushed over the surface of the composite web 3 with an optical fluid 29. In this embodiment, the input coupling element 8 has a prismatic form with a trapezoidal cross section, with the shortest side of the trapezoid corresponding to a contact face 30 that is designed for contact with the master elements 2. The shape of the input coupling element 8 may therefore also be referred to as a wedge shape.

FIG. 16A shows a first phase of the method. The master elements 2 are provided in a first carrier means 10 such that their surfaces are substantially flush. A composite web 3 is provided for the replication of the master elements. The composite web 3 is laminated on the flush surfaces of the master elements 2 with the aid of a lamination roller 7. To this end, the lamination roller 7 is brought from a storage position to the surface of the master elements 2 such that the composite web 3 is situated between the lamination roller 7 and the master elements 2.

When positioning the lamination roller 7 on the master elements 2 before the lamination, the lamination roller 7 may be moved, more particularly rolled, along a plane comprising the surface of the master elements 2. Optionally, the lamination roller 7 is also lowered downwardly onto the plane of the surfaces of the master elements 2. By preference, means for adjusting the height of the lamination roller 7 are used to this end. To compensate for variations between the heights of the master elements 2 and/or variations in the positioning of the first carrier means 10, it may be preferable to also adjust the lamination roller 7 in terms of its height. To this end, the lamination roller 7 may be lowered in steps of e.g. 50 μm until a desired pressure is attained between the lamination roller 7 and the master elements 2. Reaching the desired pressure may be identified by a suitable sensor. After the pressure is attained or after the lamination roller 7 is positioned and adjusted, said lamination roller is rolled over the surface of the master elements 2 in order to bring the composite web 3 in mechanical and optical contact with the master elements 2, without gaps and in a manner free from bubbles. The rolling of the lamination roller 7 is indicated by a horizontal arrow to the left.

FIG. 16B shows a further phase of the method following the lamination of the composite web 3 on the surface of the master elements 2. A dosing unit 28 for dosing optical fluid 29 is applied to the surface of a master element 2 at the end of the first carrier means 10. To this end, the dosing unit 28 is lowered downwardly from a storage position. The dosing unit 28 applies an amount of optical fluid 29 to the master element 2, wherein the amount of optical fluid 29 is configured to cover a contact face between the input coupling element and the composite web. The dosing unit 28 is subsequently returned to its storage position, as shown in FIG. 16C.

FIG. 16D uses the downwardly pointing arrow to schematically show the height adjustment of the input coupling element 8 which serves to bring the input coupling element 8 from a storage position to a vicinity of the master elements 2. FIG. 16E shows the input coupling element 8 after the latter was positioned on the surface of a master element 2. In this case, the input coupling element 8 is in contact with the composite web 3, which in turn is laminated on the surface of the master elements 2. The contact face 30 of the input coupling element 8 is applied to the composite web 3 such that the optical fluid 29 is situated between the input coupling element 8 and the composite web 3. The optical fluid 29 cross-links with both the contact face 30 and the composite web 3 on account of capillary forces. Thus, the optical fluid 29 completely fills the gap between the contact face 30 and the composite web 3. Since a refractive index of the optical fluid 29 is substantially identical to the refractive index of the input coupling element 8 and/or of an upper carrier film of the composite web 3, said optical fluid prevents unwanted reflections at interfaces between the contact face 30 and the composite web 3. Moreover, the optical fluid 29 may act as a lubricant which supports the sliding of the input coupling element 8 over the surface of the master element 2. The capillary forces cause the optical fluid 29 to necessarily follow the contact face 30 while it moves along the surfaces of the master elements 2. This is depicted schematically in FIG. 16F.

An exposure is implemented synchronously with the movement of the input coupling element 8 over the surface of the master elements 2. To this end, a scanning reference beam 11 is directed at the input coupling element 8 in such a way that it is diffracted to the desired exposure angle by the wedge shape. The scanning reference beam 11 follows the movement of the input coupling element 8, e.g. by virtue of a laser itself being moved along a trajectory together with a scanning unit. This is shown schematically in FIGS. 16E and 16F. Following the exposure, the input coupling element 8 is removed from the master elements 2 (not shown). In order to overcome the capillary forces and avoid a deformation or distortion of the composite web, the input coupling element 8 is preferably moved laterally/longitudinally and upwardly in a continuous movement. A possible suction effect is advantageously avoided or reduced.

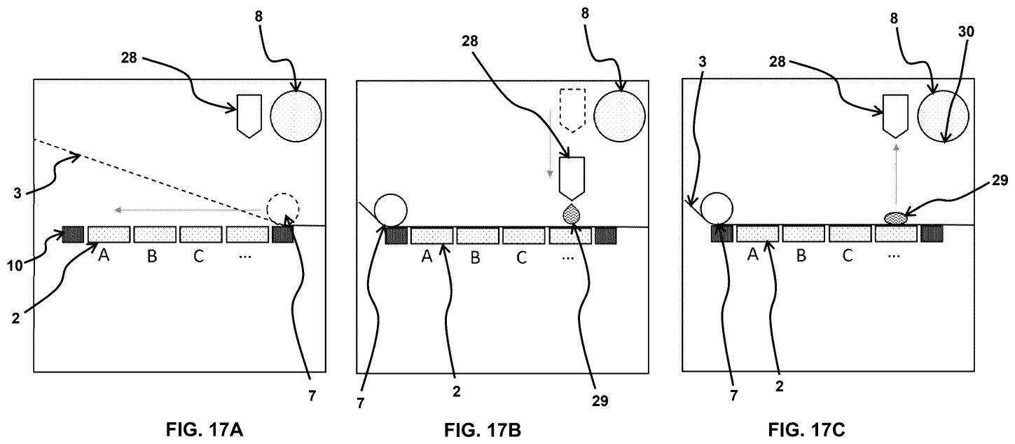

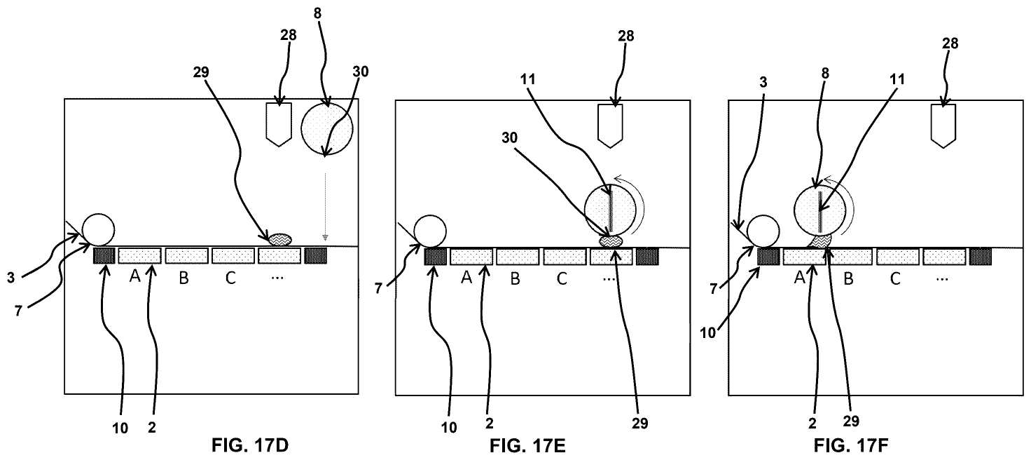

FIGS. 17A-17E show an exemplary embodiment of the invention, wherein the input coupling element 8 has a cylindrical shape. In a manner analogous to the embodiment of FIGS. 16A-16E, an optical fluid 29 is introduced for the purpose of improving the optical contact between the input coupling element 8 and the composite web 3.

FIG. 17A shows a lamination step, wherein a lamination roller 7 is brought onto the surface of the composite web 3 such that the composite web 3 is trapped between the lamination roller 7 and the first carrier means 10 or the master elements 2. The lamination roller 7 rolls over the surfaces of the master elements 2 in order to bring the composite web 3 into mechanical and optical contact therewith. FIGS. 17B and 17C show the application of an amount of optical fluid 29 to the composite web 3. This is implemented—in a manner analogous to the embodiment of FIGS. 16A-16E—by means of a height-adjustable dosing unit 28. During these steps, the cylindrical input coupling element 8 remains in a storage position situated above the plane of the laminated composite web 3 in this embodiment.

The cylindrical input coupling element 8 is then positioned from the storage position to the accessible surface of the composite web 3 such that the composite web 3 is situated between the input coupling element 8 and the first carrier means 10 or a master element 2. In this case, this positioning of the input coupling element 8 comprises a downward movement which is made possible by the height-adjustable storage of the input coupling element 8. The downward movement is depicted schematically by the downwardly directed arrow in FIG. 17D.

FIG. 17E shows the input coupling element 8 after the latter was positioned on the master elements 2. The figure also shows the introduction of a rolling movement of the input coupling element 8 over the master elements 2. The contact face 30 of the input coupling element 8 is applied to the composite web 3 such that the optical fluid 29 is situated between the input coupling element 8 and the composite web 3. The optical fluid 29 cross-links both the contact face 30 and the composite web 3 on account of capillary forces. Thus, the optical fluid 29 completely fills the gap between the contact face 30 and the composite web 3. Since a refractive index of the optical fluid 29 is substantially identical to the refractive index of the input coupling element 8 and/or of an upper carrier film of the composite web 3, said optical fluid prevents unwanted reflections at interfaces between the contact face 30 and the composite web 3.

Since the cylindrical input coupling element 8 contacts the composite web 3 only along a thin line or axis, the contact face 30 between the cylindrical input coupling element 8 and the composite web 3 is smaller than the contact face 30 between the wedge-shaped input coupling element 8 and the composite web 3. A smaller amount of optical fluid 29 is therefore sufficient to bridge the interface between the cylindrical input coupling element 8 and the composite web 3. On account of the capillary forces, the optical fluid 29 remains between the composite web 3 and the cylindrical input coupling element 8 during its movement over the surfaces of the master elements 2. This is illustrated schematically in FIG. 17F.

At the same time, a scanning reference beam 11 is directed at the input coupling element 8 synchronously with its movement. The scanning reference beam 11 follows the movement of the rolling input coupling element 8, e.g. by virtue of a laser itself being moved along a trajectory together with a scanning unit. This is shown schematically in FIGS. 17E and 17F.

### LIST OF REFERENCE SIGNS

F1 First side face of a master element
F2 Second side face of a master element
F3 Upper face of a master element
F4 Second side face of an input coupling element
F5 First side face of an input coupling element
1 Apparatus
2 Master element
3 Composite web
4 Spacer
5 Absorber layer
6 Master hologram
7 Lamination roller
8 Input coupling element
9 Input coupling section
10 First carrier means
11 Reference beam
12 Reconstructed signal/object wave
13 Reflection edge-lit HOE
14 Substrate body
15 Beam subjected to total-internal reflection
16 Transmission edge-lit HOE
17 Interference between reference beam and object beam
18 Transmission HOE
19 Reconstruction beam
20 Repeat length
21 Cover
22 Object beam
28 Dosing unit for optical fluid
29 Optical fluid
30 Contact face of the input coupling element

1. A method for replicating a plurality of holograms, the method comprising:
a. providing a multiplicity of masters, each master comprising a substrate body and at least one master hologram;
b. selecting a sequence of masters from the multiplicity of masters on the basis of the plurality of holograms to be replicated and arranging the sequence of masters on a first carrier such that upper faces of the masters are aligned in a horizontal plane;
c. detachably laminating a light-sensitive composite web on the aligned upper faces of the masters;
d. exposing the masters in order to replicate the master holograms in the light-sensitive composite web; and
e. detaching the exposed composite web from the masters,
wherein the masters are detachably incorporated in the first carrier such that a sequence and/or composition of the masters for replicating the plurality of holograms is variable, and wherein the masters are incorporated in the first carrier such that two or more faces of the masters are optically accessible for exposure purposes.

2. The method according to claim 1, wherein the masters are separated along a linear arrangement in the first carrier.

3. The method according to claim 1, wherein the method further comprises an arrangement of one or more optically transparent input couples (8) on the laminated composite web such that a partial section of the composite web is trapped between the one or more input couples and the masters during the exposure.

4. The method according to claim 1, wherein the input couples are arranged on a height-adjustable second carrier or each master is assigned a respective input couple.

5. (canceled)

6. The method according to claim 1, wherein substrate bodies of the masters have same dimensions.

7. The method according to claim 1, wherein the at least two optically accessible faces of the masters are polished, or wherein the optically accessible faces have an antireflective coating.

8. The method according to claim 1, wherein substrate bodies of the masters are formed from a material which is an optical plastic.

9. The method according to claim 1, wherein a selection of the sequence of the masters is controlled by a control unit, wherein the control unit comprises a processor and a memory.

10. The method according to claim 9, wherein exposure instructions for the sequence are stored in the memory, wherein the processor signals to a user or an actuator to set the position, the path or the wavelength of a light source in accordance with the exposure instructions.

11. The method according to claim 9, wherein the control unit is connected to a sensor, wherein the sensor reads an ID feature of the individual masters or of a storage location of the masters and transmits the ID to the control unit for controlling or monitoring the sequential arrangement.

12. The method according to claim 1, wherein the method comprises an arrangement of the masters in two parallel rows.

13. The method according to claim 2, wherein the masters are separated by light-absorbing spacers, or wherein a light-absorbing layer is applied to vertical faces of the masters.

14. The method according to claim 4, wherein a lower face of the input couples is formed by a deformable transparent input coupling section.

15. The method according to claim 6, wherein the substrate bodies of the masters have a parallelepipedal shape, or comprise a height of between 1-10 cm, a length of between 3-20 cm, and a width of between 3-20 cm.

16. The method according to claim 8, wherein the optical plastic is selected from a group consisting of polymethylmethacrylate (PMMA), polycarbonate (PC), cycloolefin polymers (COP), and cycloolefin copolymers (COC), or the optical glass is selected from the group consisting of borosilicate glass, quartz glass, B270, N-BK7, N-SF2, P-SF68, P-SK57Q1, P-SK58A, and P-BK7.

17. The method according to claim 9, an arrangement of the sequence of the masters is controlled by the control unit, wherein the processor of the control unit reads sequence data from the memory and, by an interface signal to an actuator or a user, a sequence in which the masters should be arranged.

18. The method according to claim 12, wherein the rows of the masters are separated by a light-absorbing spacer.
